(19) United States
(12) Patent Application Publication
(10) Pub. No.: US 2026/0289797 A1
(43) Pub. Date: Sep. 24, 2026

(54) SYSTEM

(71) Applicant: SoftBank Group Corp., Tokyo (JP)

(72) Inventor: Keigo FUSE, Tokyo (JP)

(73) Assignee: SoftBank Group Corp., Tokyo (JP)

(21) Appl. No.: 19/567,048

(22) Filed: Mar. 14, 2026

(30) Foreign Application Priority Data
Mar. 19, 2025 (JP) 2025-045232

(51) Int. Cl. G06T 7/246; G06F 21/64; G06N 3/0464; G06N 3/0475; G06V 10/77; G06V 40/16; G10L 25/63

(52) U.S. Cl. CPC G06T 7/246; G06F 21/64; G06N 3/0464; G06N 3/0475; G06V 10/7715; G06V 40/174; G10L 25/63

(57) ABSTRACT

A system includes a processor configured to control a camera device and a communication unit to cause a user to capture a scene of the user's exercise or work and to upload data obtained from the captured scene, execute a generative artificial intelligence model and input a prompt sentence to the generative artificial intelligence model in order to analyze, from the uploaded data, at least one of efficiency of movement, an angle of movement, and a deviation of posture, recognize an emotion of the user by using at least one of facial expression data and voice data of the user on the basis of an analysis result obtained by the generative artificial intelligence model, and adjust feedback content based on the recognized emotion, and present, to the user, a specific improvement method and provide feedback in real time on the basis of the analysis result and an emotion recognition result.

### CROSS-REFERENCE TO RELATED APPLICATION

This application is based on and claims priority under 35 USC 119 from Japanese Patent Application No. 2025-045232 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional coaching and feedback systems for exercise and work rely heavily on manual observation and static analysis of user movements. Such systems typically analyze only kinematic aspects, such as body posture or movement angles, and provide generalized, non-personalized advice that does not account for a user's emotional state or real-time reactions. As a result, users often receive feedback that is not timely, not adaptive to their current motivation or frustration level, and not sufficiently tailored to their individual needs, which reduces training efficiency and user engagement. Furthermore, existing systems generally do not integrate advanced generative artificial intelligence models capable of flexibly interpreting complex motion data and generating context-aware feedback, and they also lack integrated mechanisms for managing different usage models, such as per-use billing and subscription-based access, within a single architecture. Accordingly, there is a need for a system that can automatically capture user activity scenes, analyze motion efficiency, angles, and posture deviations using a generative AI model, recognize user emotions based on expressions and voice, adjust feedback in accordance with the recognized emotions, and deliver concrete, real-time improvement instructions while supporting flexible service monetization schemes.

### SUMMARY

To solve the above-described problems, an aspect of the invention provides a system comprising a processor, wherein the processor is configured to control a camera device and a communication unit to cause a user to capture a scene of the user's exercise or work and to upload data obtained from the captured scene. The processor is further configured to execute a generative artificial intelligence model and input a prompt sentence to the generative artificial intelligence model in order to analyze, from the uploaded data, at least one of efficiency of movement, an angle of movement, and a deviation of posture. Based on an analysis result obtained by the generative artificial intelligence model, the processor is configured to recognize an emotion of the user by using at least one of facial expression data and voice data of the user, and to adjust feedback content based on the recognized emotion. The processor is also configured to present, to the user, a specific improvement method and to provide feedback in real time on the basis of the analysis result and an emotion recognition result. In certain embodiments, the processor is configured to perform payment processing that enables the user to use a service by paying a fee for each use, and in other embodiments, the processor is configured to perform registration and management processing that enables the user to use a service by registering for a subscription, thereby allowing flexible deployment and commercialization of the system.

The term “processor” refers to one or more hardware circuits, such as a central processing unit (CPU), a graphics processing unit (GPU), a digital signal processor (DSP), an application-specific integrated circuit (ASIC), a field-programmable gate array (FPGA), or any combination thereof, that executes instructions to perform the functions described in the claims.

The term “camera device” refers to any imaging apparatus, including but not limited to a built-in or external camera of a smartphone, tablet, wearable device, or dedicated capture device, that is capable of acquiring still images or moving images of a user's exercise or work scene.

The term “communication unit” refers to any hardware and associated software that provides wired or wireless data communication, including but not limited to cellular communication, Wi-Fi, Bluetooth, Ethernet, or Internet-based communication, for transmitting and receiving data between the system and external devices or servers.

The term “exercise or work scene” refers to an action sequence or situation in which the user performs a physical activity, such as sports or fitness training, or performs a task related to work, such as manual labor, assembly, or desk work, which is captured by the camera device.

The term “uploaded data” refers to any data transmitted from the user side to the system through the communication unit, including but not limited to image data, video data, audio data, sensor data, and metadata that represent the user's exercise or work scene. The term “generative artificial intelligence model” refers to a machine learning model, such as a generative adversarial network (GAN), a transformer-based model, a large language model, or another neural network-based generative model, that is capable of generating or transforming data and of producing analysis or content based on input data and a prompt sentence.

The term “prompt sentence” refers to a textual or structured input supplied to the generative artificial intelligence model that specifies an instruction, query, or context, and that guides the operation and output of the generative artificial intelligence model when analyzing the uploaded data.

The term “efficiency of movement” refers to a quantitative or qualitative evaluation index that indicates how effectively the user's motion achieves its intended purpose, considering factors such as energy expenditure, smoothness, stability, and correctness of motion relative to a reference model.

The term “angle of movement” refers to a geometric angle or set of angles associated with the user's body segments, joints, tools, or workpieces during the exercise or work scene, measured or estimated from the uploaded data.

The term “deviation of posture” refers to a difference between an observed posture of the user and a reference posture, the difference being represented as an angular, positional, or proportional discrepancy derived from the uploaded data.

The term “facial expression data” refers to information extracted from image or video data representing the user's face, including but not limited to positions of facial landmarks, muscle movements, or derived features that are used for recognizing the user's emotional state. The term “voice data” refers to audio signals captured from the user during the exercise or work scene, including spoken utterances, non-verbal sounds, and acoustic features, which can be analyzed to infer the user's emotional state.

The term “emotion” refers to a psychological state of the user, such as happiness, satisfaction, frustration, anger, anxiety, or motivation level, inferred by analyzing at least one of facial expression data and voice data.

The term “feedback content” refers to information generated for presentation to the user, including, but not limited to, text, audio, images, or video, which provides evaluation, guidance, encouragement, or instructions for improving the user's exercise or work.

The term “specific improvement method” refers to concrete guidance or actionable instructions tailored to the user's current motion and emotional state, including, for example, changes in body movement, posture adjustments, breathing techniques, or task procedures. The term “real time” refers to a time frame sufficiently short that the user can receive feedback substantially concurrently with or immediately after the performance of the exercise or work scene, such that the feedback can be applied during the same session without a significant delay noticeable to the user.

The term “payment processing” refers to operations performed by or under control of the processor to authenticate a user, calculate usage fees, interact with external payment services if necessary, and record transactions, in order to enable the user to pay a fee for using the service.

The term “fee for each use” refers to a monetary amount charged to the user on a per-session or per-analysis basis, where the user is billed for individual uses of the service rather than on a periodic or flat-rate basis.

The term “subscription” refers to a contractual or service arrangement in which the user pays a recurring fee, such as a monthly or annual fee, in exchange for the right to access the service for a defined period or under predetermined usage conditions.

The term “registration and management processing” refers to operations performed by the processor to create, update, and store user subscription records, to manage subscription validity periods, to verify subscription status at the time of service use, and to control access to the service based on the subscription status.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

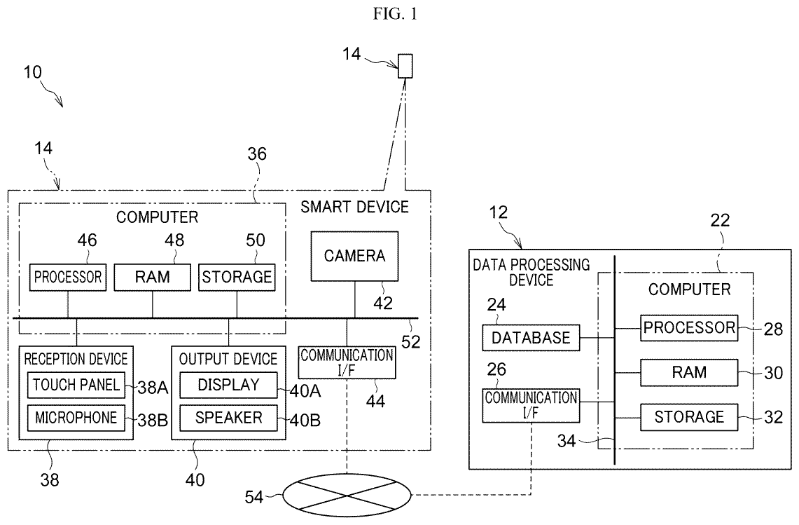

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

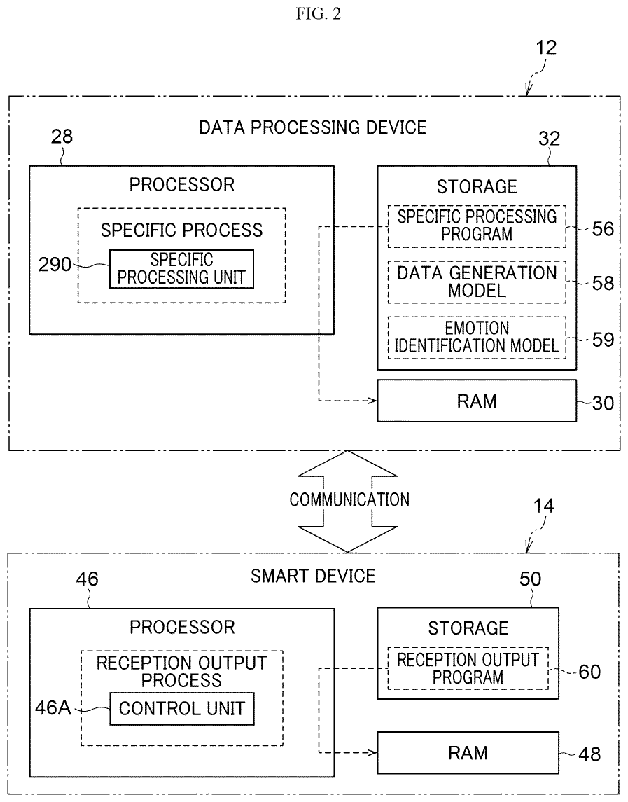

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional motion analysis services that utilize computer vision and machine learning generally treat a user's captured motion video as a monolithic input and apply fixed, pre-defined analysis logic on a server. Such systems typically suffer from several technical limitations in the way computing resources are used and in the way machine-generated feedback is produced and delivered.

First, many existing systems lack an integrated, end-to-end data processing pipeline between a portable information terminal and a server. Video capture, network transmission, server-side storage, preprocessing, and machine learning inference are often implemented as loosely coupled components with little coordination. As a result, redundant data conversions, non-normalized frame formats, and ad-hoc transmission procedures increase latency, consume unnecessary bandwidth, and lead to inefficient utilization of processors, memories, and communication interfaces.

Second, conventional machine learning systems commonly apply a fixed model interface that does not explicitly separate low-level feature extraction from high-level natural-language generation. In such systems, the server often feeds raw or minimally processed motion images directly into a model that is not guided by a structured, machine-readable description of the analysis objective. Without a dynamically constructed prompt sentence that conveys context such as motion type, user attributes, and required output structure, the generative AI model tends to produce verbose, inconsistent, or poorly targeted feedback. This degrades the technical quality of the generated output and forces the server or client to perform additional post-processing and filtering, which in turn burdens the processor and memory resources. Third, existing solutions rarely implement a unified mechanism for incorporating user emotion into the feedback generation pipeline at the system level. Emotion recognition from user expression and voice is often executed as a separate application, if at all, and is not tied tightly to the analysis result data produced by the generative AI model. Consequently, the server cannot systematically adapt the content, level of detail, or presentation order of feedback based on real-time emotional states. This lack of integration leads to repetitive or inappropriate feedback, increases the number of repeated analysis cycles, and ultimately results in inefficient usage of computational resources across both the server and the terminal. Fourth, many systems do not manage motion analysis as a structured, iterative process with machine-readable analysis indices and processing state information. Without explicit management of processing states (such as uploaded, analyzing, analysis complete) and without structured analysis indices associated with each motion scene, the server cannot efficiently schedule jobs, cache intermediate results, or provide low-latency retrieval of past analyses. This leads to higher compute load, longer response times, and a poor mapping between processor operations and the actual analytical needs of the user.

Therefore, there is a need for an improved computer-implemented system that: (i) defines a coherent pipeline from video capture on a portable information terminal to structured analysis and feedback generation on a server, (ii) uses a dynamically constructed prompt sentence to condition a generative AI model on motion-specific and user-specific context, (iii) integrates emotion recognition into the same computational pipeline such that the generated feedback can be automatically adjusted based on emotional state, and (iv) maintains structured analysis indices and processing states to support iterative, low-latency, resource-efficient motion improvement cycles. By improving these aspects, the underlying computer technology for motion analysis, feedback generation, and human-computer interaction can be substantially enhanced in terms of efficiency, adaptability, and consistency of machine-generated output.

The specific processing by the specific processing unit 290 of the data processing device 12 in Example 1 is realized by the following means.

The present invention provides a server comprising at least one processor and at least one memory storing instructions which, when executed by the at least one processor, cause the server to implement an integrated data processing pipeline including: receiving motion image data and user identification information transmitted from a portable information terminal via a communication network; verifying data integrity of the received motion image data and storing the motion image data in an external storage device in association with the user identification information and processing state information; performing preprocessing by acquiring the motion image data from the external storage device, decomposing the motion image data into a frame sequence, normalizing the frame sequence to a predetermined resolution and frame rate, and converting the normalized frame sequence into feature data expressed as numerical arrays; generating, based on the feature data and condition information including at least a motion type, a user attribute, and an output format, a prompt sentence that defines an analysis objective and an output format for a generative AI model; executing the generative AI model using the feature data and the prompt sentence as inputs to compute positions of body parts, joint angles, motion speeds, and motion patterns in the motion scene, to compare the motion patterns with reference motion patterns, and to generate analysis result data including motion efficiency, posture deviation, and timing deviation together with feedback text expressed in a natural language; performing emotion-aware adjustment by inputting the analysis result data together with expression data and voice data of the user into a recognition processing program to determine an emotional state of the user and adjusting content, expression level, and presentation order of the feedback text according to the emotional state; and generating structured data including adjusted feedback text and analysis indices, transmitting the structured data to the portable information terminal via the communication network, and enabling the portable information terminal to present the structured data as a screen display or an audio output so that the user can iteratively capture and improve motion scenes based on the structured analysis and emotion-aware feedback. This enables improvement of computer technology by providing a tightly integrated, context-conditioned, and emotion-adaptive server-side processing architecture that reduces redundant computation and data transfer, increases the efficiency and consistency of generative AI analysis, and supports low-latency, iterative motion feedback cycles between the server and the portable information terminal.

The term “system” refers to a combination of at least one server, at least one portable information terminal, and one or more communication networks, together with hardware and software components configured to execute the claimed processing.

The term “server” refers to an information processing apparatus including at least one processor and at least one memory that executes programs to perform reception, storage, analysis, and feedback processing on data received from a portable information terminal via a communication network.

The term “processor” refers to a hardware computation unit, such as a central processing unit or graphics processing unit, capable of executing instructions to perform logical operations, numerical calculations, control flows, and data processing required by the claimed functions. The term “memory” refers to a hardware storage resource, such as a semiconductor memory or magnetic storage device, configured to store programs, parameters, intermediate data, and result data used and generated by the processor.

The term “portable information terminal” refers to a user-operated electronic device, such as a handheld or wearable computing device, that includes at least an input/output device, a storage device, and a communication device, and is configured to capture, store, and transmit motion image data.

The term “input/output device” refers to hardware and software components of the portable information terminal that support user interaction and data acquisition, including at least a camera, a display, a touch interface, a microphone, or a speaker.

The term “camera” refers to an image capture device including an optical system and an image sensor that converts incident light into electronic signals to generate still image data or motion image data.

The term “storage device” refers to a non-transitory computer-readable medium, such as a flash memory or other mass storage, configured to record motion image data, metadata, and application data on the portable information terminal or the server.

The term “communication device” refers to hardware and software modules that enable data transmission and reception over a communication network using one or more communication protocols.

The term “communication network” refers to a wired or wireless network infrastructure, including at least a local network or a wide-area network, used to transfer data between the portable information terminal and the server.

The term “communication protocol” refers to a set of rules and procedures, implemented in software and hardware, for formatting, transmitting, and receiving data over the communication network.

The term “motion scene” refers to a sequence of physical movements performed by a user and captured as image information, typically recorded as a motion image including a series of frames.

The term “motion image data” refers to digital data representing a motion scene, including a sequence of image frames and associated metadata, stored in a predetermined file format. The term “user identification information” refers to data that uniquely or semi-uniquely identifies a user, such as a user ID, account identifier, or other identification token used by the server to associate data and processing results with a particular user.

The term “processing state information” refers to data indicating a current status of processing for a given motion image, including at least states such as uploaded, analyzing, and analysis complete.

The term “external storage device” refers to a storage resource located outside a main memory of the server, such as a network-connected storage or other persistent storage system, used to store motion image data and related information.

The term “image processing program” refers to software executed by the processor to perform operations on motion image data, including at least decomposition into frames, resizing, and format conversion.

The term “frame sequence” refers to an ordered set of image frames obtained from motion image data, each frame representing a still image at a corresponding time point in the motion scene.

The term “normalizing” refers to adjusting characteristics of image data, including at least spatial resolution and temporal sampling rate, to predetermined values suitable for subsequent processing.

The term “feature data” refers to numerical representations derived from motion image data or frame sequences, such as pixel values, keypoint coordinates, or other numerical arrays, suitable for input to a machine learning model.

The term “condition information” refers to data specifying analysis parameters, including at least a motion type to be analyzed, a user attribute, and an output format for an analysis result.

The term “motion type” refers to a classification label or descriptor specifying a category of movement included in a motion scene, such as a particular exercise or activity.

The term “user attribute” refers to information about a user's characteristics relevant to analysis, such as experience level, physical condition, or preference for a style of feedback.

The term “output format” refers to a specification of a desired structure, language, or presentation style of feedback text or analysis data generated by the system.

The term “prompt sentence” refers to a text string generated by the server that defines an analysis objective and a required output format, and that is supplied as input to a generative AI model to condition its behavior.

The term “generative AI model” refers to a machine-learning-based model, implemented using a machine learning framework, that generates output data such as natural-language text based on input feature data and a prompt sentence.

The term “machine learning framework” refers to a software library or platform that enables definition, training, and execution of machine learning models, including at least those capable of implementing generative AI models.

The term “analysis result data” refers to structured or semi-structured data generated by the generative AI model, including at least computed motion metrics and derived assessments regarding the user's motion.

The term “motion efficiency” refers to an assessment metric derived from computed motion patterns, representing how effectively a user's body movements achieve a given motion objective.

The term “posture deviation” refers to an amount or type of difference between a user's actual posture and a desired reference posture during at least a portion of a motion scene. The term “timing deviation” refers to a difference between temporal characteristics of a user's motion and reference timing patterns, including at least inconsistencies in speed or rhythm.

The term “reference motion patterns” refers to motion data representations, such as trajectories or angle sequences, used as a basis for comparison with a user's motion patterns to evaluate performance.

The term “feedback text” refers to information expressed in a natural language and generated by the generative AI model or by post-processing, which describes analysis results and provides advice for improvement.

The term “expression data” refers to data representing facial expressions or other user appearance features derived from image or video data, used for emotion recognition. The term “voice data” refers to audio information capturing the user's voice or sound emissions, used as input for analysis including emotion recognition.

The term “recognition processing program” refers to software executed by the processor that analyzes expression data and voice data to determine an emotional state of the user.

The term “emotional state” refers to a classification of a user's current emotional condition, such as positive, neutral, or negative, determined by processing expression data and voice data.

The term “feedback adjustment” refers to processing that modifies content, expression level, and presentation order of feedback text based on at least the emotional state of the user and the analysis result data.

The term “analysis indices” refers to numerical or categorical indicators computed from analysis result data, representing quantitative or qualitative aspects of the user's motion performance.

The term “structured data” refers to data organized in a predetermined schema or format, such as a set of fields or elements, suitable for reliable parsing and display by the portable information terminal.

The term “user interface program” refers to software on the portable information terminal that interprets structured data received from the server and generates corresponding screen displays or audio outputs for the user.

The term “screen display” refers to visual information presented on a display unit of the portable information terminal, including text, icons, graphs, or other graphical elements representing analysis and feedback.

The term “audio output” refers to sound signals generated by the portable information terminal, such as spoken feedback or audio cues, representing analysis and feedback content. The term “usage unit” refers to a defined unit of service consumption, such as a single execution of the analysis and feedback adjustment pipeline for a given motion scene.

The term “usage fee” refers to a monetary amount determined based on one or more usage units and charged to a user for use of the analysis and feedback services.

The term “payment service” refers to an external or internal system that processes financial transactions, including at least authorization and settlement of payments for usage fees.

The term “payment processing” refers to operations performed by the server in cooperation with a payment service to request, authorize, and record payment of a usage fee.

The term “continuous usage contract” refers to an agreement associated with a user that specifies conditions under which the user is allowed to repeatedly use the analysis and feedback services, such as a subscription.

The term “registration information” refers to contract-related data stored for each user, including terms, validity period, and service level for a continuous usage contract.

The term “predetermined contract condition” refers to a condition derived from registration information, such as an active subscription status, that governs whether additional payment processing is required for providing feedback.

In one embodiment, a system includes a server and at least one terminal operated by a user. The server and the terminal are connected via a communication network. The server includes at least one processor, at least one non-transitory memory, and access to an external storage device. The terminal includes at least one processor, at least one memory, a camera, a display, a microphone, a speaker, and a communication interface.

The terminal uses a camera module, which may include a lens, an image sensor, and a camera control circuit, to capture a motion scene of the user. The terminal converts analog signals from the image sensor into digital image frames, encodes the frames using a video codec such as an H.264 or H.265 encoder implemented in hardware or software, and stores the encoded motion image data in a memory or a local storage device as a file in a container format such as MP4. The terminal additionally stores metadata such as capture time, frame rate, resolution, and device identifier.

The terminal executes an application program that provides a user interface for selecting previously captured motion image data and for initiating transmission of the motion image data to the server. The terminal uses a communication interface, such as a wireless network adapter supporting one or more of a cellular protocol or a wireless local area network protocol, to send the motion image data and user identification information to the server via a network protocol stack that includes at least a transport protocol and an application-layer protocol such as HTTPS. The terminal structures the outgoing data, for example, as a request message including a binary segment for the video data and a textual or structured segment for the user identification information and additional condition information.

The server receives incoming request messages by using a communication interface and a server application. The server parses the request, extracts the motion image data and associated user identification information, and temporarily stores the motion image data in an input buffer in memory. The server computes a checksum or hash value, for example using a cryptographic hash function, and verifies that the computed value matches an expected value, which may be included in the request or computed independently. The server then stores the motion image data in an external storage device, such as a network-attached storage or a cloud storage service, and associates a unique identifier, the user identification information, and processing state information with the stored data in a database managed by a database management system.

The server uses an image processing program, implemented for example with a multimedia processing library, to read the motion image data from the external storage device and decode the video stream into a plurality of frames. The server resizes each frame to a predetermined resolution, such as a defined width and height, and adjusts the sampling interval to a predetermined frame rate. The server converts each frame into a numerical array of pixel values and stores these arrays as a sequence of tensors in memory. The server may perform additional preprocessing operations such as normalization of pixel intensity values, background suppression, or cropping based on a region of interest that contains the user's body.

The server applies a body pose estimation model to each frame or to a subset of frames. In one embodiment, the server uses a convolutional neural network with a backbone architecture that extracts multi-scale feature maps from each frame and one or more head networks that output keypoint heatmaps for body joints. The server converts these heatmaps into two-dimensional coordinates for joints including at least shoulders, elbows, wrists, hips, knees, and ankles. The server arranges the coordinates across the temporal dimension to form a time series of joint positions.

The server converts the time series of joint positions into derived feature data. The server computes joint angles, such as knee flexion angle, hip flexion angle, and trunk inclination angle, by applying geometric formulas to the joint coordinates for each frame. The server computes temporal derivatives such as angular velocity and angular acceleration by applying finite difference operations over successive frames. The server organizes these results into a structured data representation, for example, a multi-dimensional tensor with dimensions corresponding to time, joint type, and feature type. This structured feature data is then stored in memory as input to the generative AI model.

The server maintains one or more reference motion patterns in memory or in a storage device. In one embodiment, the server stores reference patterns as time-normalized sequences of joint angles and velocities corresponding to a desired motion, such as a standard squat or a standard running stride. The server may also store tolerance ranges or statistical models, such as mean and variance of each feature, obtained from a training dataset of expert performers. The server uses these reference motion patterns as a basis for comparison when computing analysis result data.

The server generates a prompt sentence that conditions the generative AI model. The server composes the prompt sentence by concatenating different text segments derived from the motion type, user attribute, desired output format, and system-defined templates. For example, when the motion type is a squat exercise, the server can generate a prompt sentence such as:

“The input is a motion scene video of a user performing body-weight squats. Analyze the user's posture, joint angles, and movement speed throughout the exercise. Identify specific problems in the form and generate concrete, easy-to-understand advice to improve the squat technique. Output the results in clear English bullet points.”

In another example, when the motion type is a running motion, the server can generate a prompt sentence such as:

“Analyze this running motion video frame by frame. Focus on knee lift, foot landing position, and upper body posture, and generate specific tips that can help the user run more efficiently and reduce injury risk.”

The server constructs the prompt sentence as a sequence of tokens in memory and passes the prompt sentence, together with the structured feature data, to the generative AI model. The server implements the generative AI model using a machine learning framework. In one embodiment, the server uses a neural network that combines a temporal encoder and a language decoder. The server uses the temporal encoder, which can be a recurrent neural network, a temporal convolutional network, or a transformer-based encoder, to process the time series of joint angles and velocities. The temporal encoder outputs an encoded representation of the motion, such as a fixed-length embedding vector or a sequence of latent vectors. The server uses a language decoder network, such as a transformer-based decoder, that generates natural-language tokens conditioned on both the prompt sentence tokens and the encoded motion representation.

The server runs the generative AI model on one or more processors, such as general-purpose processors or accelerators. The server loads the model parameters, which were obtained by an offline training process, from a storage device into memory. During operation, the server performs matrix multiplications, non-linear activation functions, attention weight computations, and other neural network operations defined by the architecture. The server does not merely automate a human-readable analysis; the server uses specific numerical encodings and internal attention mechanisms that correlate motion features with linguistic descriptors in a way that cannot be replicated by simple rule-based systems.

In one training embodiment, the server or an associated training system uses a loss function that combines a language modeling loss, such as cross-entropy between predicted tokens and ground-truth feedback tokens, with a regularization term that encourages consistent mapping between motion feature patterns and specific feedback categories. The training system updates model parameters by applying a gradient-based optimization algorithm, such as stochastic gradient descent or Adam, using backpropagation through time for temporal components. The training system may apply data augmentation, for example, by temporally scaling motion sequences, adding synthetic noise to joint coordinates, or mirroring left-right body positions, to increase robustness and reduce overfitting. As a result, the trained generative AI model can generalize to new motion data while maintaining stable and specific feedback behavior.

The server uses the generative AI model to compute analysis result data. The server inputs the prompt sentence tokens and the motion feature representation to the model. The model's encoder-decoder architecture computes attention scores that relate textual parts of the prompt sentence, such as “knee lift” or “back straightness,” to numerical motion features that represent joint angles and segment orientations. The server obtains as output not only natural-language feedback tokens but also intermediate categorical indicators, such as predicted labels for posture quality, movement smoothness, and joint load. The server aggregates these indicators into analysis indices, for example, a numerical score for posture, a numerical score for timing, and categorical tags indicating specific issues, such as “insufficient depth” or “knee valgus.” The server stores the analysis result data and the generated feedback text in memory or in a storage device.

The server integrates emotion recognition into the pipeline. In one embodiment, the terminal captures expression data by using the camera and captures voice data by using the microphone while the user interacts with feedback or during motion. The terminal transmits this data to the server. The server uses a recognition processing program that applies a dedicated neural network, such as a convolutional or transformer-based model for facial expression and a recurrent or transformer-based model for audio spectrograms, to output an emotional state classification, for example, “frustrated,” “neutral,” or “confident.” The server uses this classification to adjust the generated feedback, for example, when the emotional state is “frustrated,” the server may instruct the generative AI model, via an additional prompt segment or a secondary rule, to produce more encouraging and simpler feedback. In contrast, if the emotional state is “confident,” the server may allow the feedback to include more technical details. This adjustment is performed by modifying either the prompt sentence or by applying a post-processing rule set on the generated text, which is implemented in software and executed by the processor.

The server composes structured data that contains the adjusted feedback text, analysis indices, and references to the underlying motion image data. The server organizes the structured data as a data object with named fields, such as “summary,” “detailed_advice,” “posture_score,” and “timing_score.” The server transmits this structured data to the terminal over the communication network using the same or a similar application-layer protocol used for video upload.

The terminal receives the structured data and stores it in local memory. The terminal executes a user interface program that parses the structured data and generates graphical user interface elements such as text sections, bullet lists, and graphs. The terminal displays the feedback text on the display and may output synthesized speech via the speaker using a text-to-speech engine. The terminal can also show comparison views, for example, by loading structured data from multiple previous sessions and plotting the posture score across time. The user reads or listens to the feedback and adapts subsequent motion accordingly.

The system provides technical advantages beyond merely automating a human expert's analysis. The server reduces communication load by transmitting compact feature representations when necessary and by normalizing frame rates and resolutions to predetermined values before analysis. The server improves computation efficiency because the temporal encoder processes standardized tensor shapes that allow optimized batch operations on hardware such as vector units and accelerators. The use of a prompt sentence that explicitly encodes motion type, user attributes, and desired output format reduces the amount of post-processing and reformatting on the server and terminal, because the generative AI model is guided to produce context-appropriate, structurally consistent output. The integration of emotion recognition into the same computational pipeline reduces the number of repeated analysis cycles by aligning feedback complexity with the user's current state, thereby reducing redundant data processing.

The server improves accuracy because the generative AI model uses a representation specifically tailored to time-varying joint angles and velocities, and uses reference motion patterns stored in machine-readable form. The comparison of user features to reference patterns is implemented as numeric operations and learned attention mechanisms, not as ad-hoc thresholds. This enables the server to capture subtle coordination issues and joint timing misalignments that are difficult to identify with simple rule-based algorithms or straightforward human visual inspection.

The system further improves the internal data management of analysis operations. The server maintains processing state information for each motion scene, allowing efficient scheduling of batch analysis jobs and quick retrieval of previous results. The server can update only those components that require re-analysis when a new motion is captured, which reduces redundant reading of large video files from external storage. The server can also cache intermediate feature data for frequently analyzed motion types, thereby shortening overall response times.

In alternative embodiments, the server uses different neural network architectures for the generative AI model, such as a sequence-to-sequence recurrent network, a transformer encoder-decoder pair, or a hybrid system combining a graph neural network for skeletal data with a language model for text generation. The server may deploy different pose estimation networks depending on device capability or motion type, including lightweight networks optimized for lower resolution inputs or multi-view networks when multiple cameras are available. The server may offload part of the feature extraction to the terminal when the terminal has sufficient processing capability, for example by running a lightweight pose estimation model locally and sending only joint coordinate sequences to the server. In such an embodiment, the communication load is further reduced because raw video frames need not be transmitted.

The terminal can operate in various environments, such as indoors or outdoors, and may use additional sensors, such as inertial sensors, to complement camera data. The server can integrate these sensor readings into the feature data, for example by concatenating accelerometer and gyroscope features with pose-based features, thereby further improving robustness and accuracy of the motion analysis.

By structuring data in specific numerical and textual forms, by applying defined preprocessing and neural network architectures, and by managing processing states and indices in a systematic way, the system provides a concrete improvement in computer technology. The system optimizes the interaction between the terminal and the server, reduces unnecessary data transfer and computation, increases the accuracy and consistency of generative AI analysis, and enables low-latency, iterative feedback cycles that adapt to both the physical motion and the emotional condition of the user.

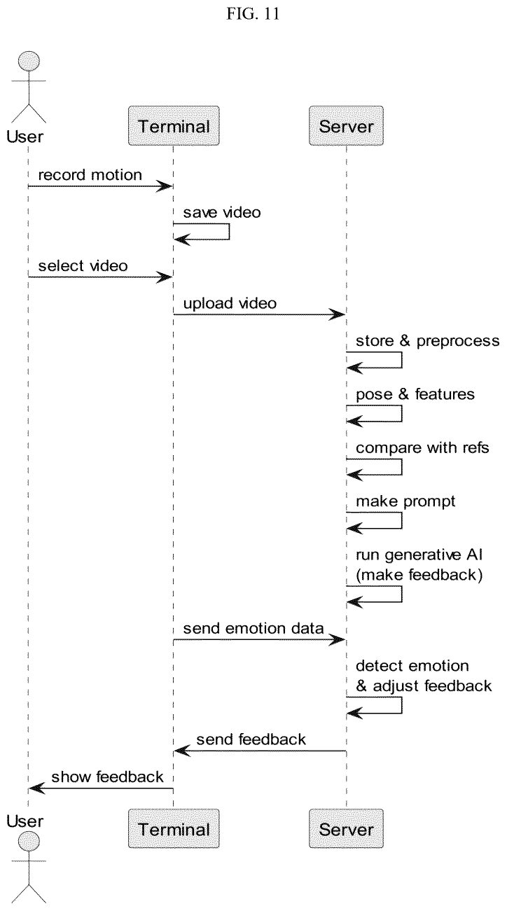

The following describes the processing flow using FIG. 11.

### Step 1

The user positions the terminal so that the entire body is visible in the camera view and starts recording a motion scene.

Input: A real-world physical motion performed by the user.

Output: Digital motion image data stored in the terminal.

The terminal activates the camera module, converts optical signals from the image sensor into digital image frames, encodes the frames using a video codec, and writes the encoded frames into a video file in a storage device. The terminal appends metadata such as timestamp, resolution, and frame rate to the file header. The user stops recording, and the terminal closes the file and registers it in a media index so that the file can be selected by applications.

### Step 2

The user launches an application on the terminal and selects a recorded motion scene for analysis.

Input: A list of motion image files stored on the terminal and user selection operations.

Output: A selected motion image file path and associated metadata.

The terminal displays thumbnails or file names of available videos using a user interface component. The user touches or clicks on one item, and the terminal retrieves the corresponding file path and metadata, such as duration and file size, from its local media database. The terminal prepares this information as an internal data structure for subsequent upload.

### Step 3

The terminal uploads the selected motion image data and user identification information to the server.

Input: The selected motion image file and user identification information.

Output: A network request containing the motion image data and identification payload sent to the server.

The terminal opens the video file using a file I/O API, reads the file contents into a transmission buffer, and constructs a network message that includes a binary segment for the video data and a structured segment for the user identification information and condition information (for example, motion type and desired analysis language). The terminal uses a communication interface to send the message to the server via a transport protocol. The terminal waits for a confirmation response from the server and may display an upload progress bar based on the amount of data successfully transmitted.

### Step 4

The server receives and stores the motion image data and updates processing state information.

Input: A network message containing motion image data, user identification information, and condition information.

Output: Stored motion image data in an external storage device and a database record with processing state information.

The server parses the incoming message, extracts the binary video content and textual fields, and writes the video content into a temporary buffer in memory. The server computes a checksum over the buffered data and, if available, compares it with a checksum included in the message to verify integrity. After validation, the server writes the video data to an external storage device under a generated unique identifier and inserts or updates a database record that links the unique identifier with the user identification information, condition information, and a processing state set to “uploaded.”

### Step 5

The server decodes and preprocesses the motion image data into normalized frame sequences and feature data.

Input: Stored motion image data referenced by a unique identifier.

Output: A time-ordered sequence of normalized frames and corresponding numerical feature data in memory.

The server reads the motion image data from the external storage device and uses an image processing program to decode the video stream into individual frames. The server resizes each frame to a predetermined resolution and temporally resamples the frame sequence to a predetermined frame rate by selecting or interpolating frames. The server converts each frame into an array of pixel values normalized to a fixed range and stores these arrays in a contiguous memory region as a tensor. Based on these pixel tensors, the server may apply operations such as cropping around the user's body and reducing color channels, thereby generating preprocessed feature data prepared for subsequent pose estimation.

### Step 6

The server performs pose estimation and derives motion feature sequences from the frame sequence.

Input: The normalized frame sequence tensor.

Output: Time-series feature data representing joint positions, joint angles, and temporal motion characteristics.

The server executes a pose estimation model that processes each frame tensor to output heatmaps for keypoints corresponding to major joints. The server computes joint coordinates from the heatmaps and arranges the coordinates across all frames to form joint position trajectories. The server then applies geometric formulas to compute joint angles for each frame and uses numerical differentiation to compute angular velocities and accelerations between consecutive frames. The server stores these results as a multi-dimensional tensor indexed by time, joint identifier, and feature type.

### Step 7

The server compares the user's motion features with reference motion patterns and computes analysis indices.

Input: Time-series motion feature data and stored reference motion patterns.

Output: Analysis indices including motion efficiency, posture deviation, and timing deviation.

The server aligns the user's feature sequence with one or more reference motion patterns using a temporal alignment algorithm, such as dynamic time warping or normalized resampling. The server computes differences between corresponding joint angles and velocities at aligned time points and aggregates these differences using statistical functions, for example mean absolute deviation or root-mean-square error. The server calculates composite scores for motion efficiency, posture deviation, and timing deviation by applying predetermined weighting factors to the per-joint metrics and stores these scores and deviation patterns as analysis indices in memory.

### Step 8

The server generates a prompt sentence that conditions the generative AI model.

Input: Analysis indices, motion type, user attribute, and output format information.

Output: A prompt sentence text string.

The server selects a template based on the motion type and desired output format and fills template variables with specific values derived from the analysis indices and user attributes. For a squat motion, the server may generate a prompt sentence such as:

“The input is a motion scene video of a user performing body-weight squats. Analyze the user's posture, joint angles, and movement speed throughout the exercise. Identify specific problems in the form and generate concrete, easy-to-understand advice to improve the squat technique. Output the results in clear English bullet points.”

The server stores this prompt sentence as a sequence of characters or tokens and prepares it as input for the generative AI model together with the motion feature representation.

### Step 9

The server executes the generative AI model using the prompt sentence and motion feature data to generate text-based analysis and advice.

Input: The prompt sentence and the time-series motion feature data or its encoded representation.

Output: Natural-language feedback text and detailed analysis result data.

The server encodes the motion feature data using a temporal encoder network, obtaining a latent representation of the user's motion. The server tokenizes the prompt sentence and feeds both the prompt tokens and the latent motion representation into a language decoder network. The decoder applies neural operations, such as attention over prompt tokens and motion features, to generate a sequence of output tokens corresponding to words or subwords in natural language. The server converts these tokens into feedback text, which describes detected issues and recommended corrections, and additionally extracts any structured labels or scores produced by the model as part of the analysis result data.

### Step 10

The server determines the user's emotional state and adjusts the feedback text accordingly.

Input: Analysis result data, feedback text, and emotion-related data including expression data and voice data.

Output: Emotion-adjusted feedback text and possibly updated analysis indices.

The server receives expression data and voice data from the terminal or retrieves previously stored emotion-related data associated with the same session. The server processes these data using an emotion recognition model that outputs an emotional state classification. Based on this classification, the server applies adjustment rules, for example, by appending clarifying sentences, simplifying technical terms, or changing the level of criticism. The server modifies the feedback text accordingly, for example transforming “Your depth is insufficient and your knee alignment is poor” into “You are doing well overall; next, try to go a bit deeper and pay attention to keeping your knees in line with your toes.” The server stores the adjusted feedback text as part of the final analysis result.

### Step 11

The server constructs structured feedback data and transmits it to the terminal.

Input: Adjusted feedback text, analysis indices, and identifiers for the motion image data.

Output: A structured feedback message sent to the terminal.

The server packages the adjusted feedback text, numerical scores, categorical tags, and references to the motion scene into a structured format with defined fields. The server serializes this structure into a message suitable for transmission and sends it to the terminal via the communication network using an application-layer protocol. The server optionally updates the processing state in the database to indicate that analysis is complete and feedback has been generated.

### Step 12

The terminal receives, parses, and displays the feedback to the user.

Input: A structured feedback message from the server.

Output: A rendered feedback presentation on the display and/or audio output for the user.

The terminal receives the incoming message through the communication interface and writes it to a receive buffer in memory. The terminal executes a user interface program that parses the structured fields into internal variables representing text sections and scores. The terminal then generates user interface elements, such as headings, bullet lists, graphs, and progress indicators, and renders them on the display. The terminal may also pass the feedback text to a text-to-speech engine to create audio output via the speaker. The user views or listens to the feedback and decides how to adjust the next motion session.

### Step 13

The user interprets the feedback and performs a new motion scene to iteratively improve performance.

Input: The presented feedback content and the user's understanding of the advice.

Output: A modified physical motion performed by the user and, if recorded, new motion image data.

The user reads the specific recommendations, such as “bend your knees more deeply,” “keep your back straight,” or “land your feet closer to beneath your center of mass,” and adjusts body posture, timing, or force accordingly in the next motion attempt. The user initiates a new recording on the terminal, thereby generating another set of motion image data that can be uploaded and processed through the same sequence of steps for further refinement.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented motion analysis systems suffer from several technical limitations in how sensor data is processed, interpreted, and fed back to users in real time. First, known systems typically rely on fixed rule-based algorithms or static machine learning models that operate directly on raw or minimally processed video streams. Such architectures often treat video data as a monolithic input, without an explicit pipeline that separates frame-level preprocessing, pose feature extraction, motion evaluation, and natural-language generation. As a result, the systems tend to be computationally inefficient, are difficult to scale when processing large volumes of video data from multiple users, and frequently produce coarse or generic feedback that is not temporally aligned with specific segments of the recorded motion.

Second, in many existing approaches, the computer system does not dynamically adapt the depth or focus of analysis based on the detected risk level or inefficiency of a particular posture. The same processing and output format are applied uniformly to all frames and all time intervals, regardless of whether the user's motion is safe or high-risk. This leads to suboptimal use of limited computation, network, and model-inference resources, and it also fails to provide fine-grained guidance where it is most needed. From a computer technology perspective, there is no mechanism in the processing pipeline to control, based on machine-generated evaluation metrics, how and when a generative model is invoked or how its input is formulated for different risk conditions.

Third, existing systems typically lack an integrated, iterative feedback loop between low-level motion evaluation and high-level natural-language guidance. In many implementations, the analysis is performed once, a static report is generated, and any subsequent improvement attempts by the user are treated as independent sessions. The computer does not maintain a structured, iterative process in which updated motion evaluation information is automatically fed back into a generative model through revised prompt sentences, so that the system can generate stepwise, increasingly targeted improvement proposals. Consequently, the system cannot effectively support progressive refinement of the user's motion over multiple iterations, and the underlying computing pipeline is not optimized for iterative human computer interaction.

Fourth, conventional architectures rarely provide a robust mechanism for synchronizing generated feedback with the temporal structure of the recorded motion at the level of the user interface. Even when detailed analysis is possible at the backend, the system often fails to generate data structures that explicitly map evaluation results and generated text to specific time segments of the video. Without time-series correspondence information between motion data and feedback, the terminal device cannot reliably control the display of feedback in association with video playback positions. This leads to a disjointed user experience and underutilizes the capabilities of modern computing platforms to present context-aware, segment-specific information.

Accordingly, there is a need for an improved computer-implemented system that (i) structures motion analysis as a multi-stage data processing pipeline from video capture to preprocessed motion analysis data, (ii) executes pose estimation and motion recognition models to generate explicit motion evaluation information including work efficiency and safety indices, (iii) dynamically constructs and adjusts prompt sentences for a generative AI model based on that evaluation information, (iv) generates feedback information that is temporally aligned with the motion data, and (v) supports iterative improvement by reusing updated motion evaluation information to drive multiple rounds of generative feedback. Such a system would improve the technical functioning of the underlying computing environment by optimizing model invocation, data representation, and user interface synchronization for real-time motion guidance.

The specific processing by the specific processing unit 290 of the data processing device 12 in Application Example 1 is realized by the following means.

The present invention provides a server comprising a processor, a storage device, a communication interface, and a program stored in the storage device and executable by the processor, the processor being configured to receive, via the communication interface, moving image data of a user's physical motion or work motion captured by a user terminal including at least one of a portable terminal device and a wearable display device; to execute an image processing program to convert the moving image data into motion analysis data by extracting a plurality of still images, resizing and reformatting the still images, and generating preprocessed data suitable for machine-learning-based analysis; to execute at least one of a posture estimation model and a motion recognition model using the motion analysis data so as to compute feature information including joint positions, joint angles, and time-series change information of a human body and to generate motion evaluation information including at least one of a work efficiency index and a safety index; to generate a prompt sentence that incorporates the motion evaluation information as structured input to a generative AI model, to input the prompt sentence into the generative AI model, and to cause the generative AI model to output natural-language text including explanatory text and improvement proposal text; to generate feedback information for presentation to the user based on the natural-language text; to generate presentation data including time-series information that associates the feedback information with corresponding time intervals of the moving image data, and to transmit the presentation data to the user terminal so that the user terminal displays the feedback information in association with a playback position of the moving image data; and to dynamically modify contents of the prompt sentence in accordance with at least one of a posture risk level and an efficiency degradation level included in the motion evaluation information, thereby causing the generative AI model to generate more detailed improvement proposal text for time intervals having higher risk or inefficiency, and to input revised prompt sentences again to the generative AI model based on updated motion evaluation information obtained after presentation of feedback, so as to generate stepwise improvement proposal texts over multiple iterations. This enables the computer system to implement an optimized, multi-stage motion analysis and feedback pipeline that adaptively controls generative AI invocation based on machine-generated evaluation metrics, improves utilization of computing and communication resources by focusing detailed feedback on high-risk or inefficient motion segments, and enhances the technical operation of user terminals by providing temporally synchronized, iterative guidance that supports progressive refinement of user motion.

The term “system” refers to a combination of hardware and software components including at least one processor, a storage device, a communication interface, and one or more user terminals, which cooperate to perform motion analysis and feedback processing as described in the claims.

The term “processor” refers to an electronic data processing unit, such as a central processing unit or another programmable processing circuit, that executes instructions of one or more programs to perform the functions described in the claims.

The term “storage device” refers to a non-transitory computer-readable medium, such as a semiconductor memory, magnetic storage, or optical storage, that stores programs, parameters, motion data, and analysis results used by the processor.

The term “communication interface” refers to a hardware and software module that enables data exchange between the system and external devices or networks, including wired or wireless communication controllers and associated protocols.

The term “user terminal” refers to an information processing device operated by a user, including but not limited to a portable terminal device or a wearable display device, that captures motion data, transmits the data to the system, and presents feedback information to the user.

The term “portable terminal device” refers to a handheld or body-carried electronic device having at least a display, an imaging function, a processor, and a communication function, such as a smartphone, tablet, or similar mobile computing apparatus.

The term “wearable display device” refers to an electronic apparatus configured to be worn on a user's body, having a display section, a processor, and a communication function, and capable of presenting information in a heads-up or near-eye manner.

The term “moving image data” refers to time-series image data representing a sequence of images of a user's motion, acquired by an image capture function of the user terminal, and including associated timing information.

The term “image capture function” refers to a hardware and software configuration of the user terminal that acquires optical information of a scene through an imaging element and generates corresponding digital image or video data.

The term “image processing program” refers to a software module executed by the processor that performs operations on image or video data, including decoding, frame extraction, resizing, format conversion, and preparation of data for analysis.

The term “still image” refers to a single frame extracted from moving image data, representing a static image at a specific time point within a motion sequence.

The term “motion analysis data” refers to preprocessed data derived from moving image data, including one or more still images and associated parameters converted to a predetermined resolution and format suitable for machine-learning-based analysis.

The term “preprocessed data” refers to data that has undergone conversion or normalization, such as resizing, reformatting, or scaling, so that it can be directly input to an analysis model. The term “posture estimation model” refers to a computational model, such as a machine learning model or a neural network, that estimates body joint positions and configurations from image data.

The term “motion recognition model” refers to a computational model that recognizes types of human motion or actions, and temporal patterns of such motion, based on input image or feature data.

The term “feature information” refers to structured data representing characteristics extracted from motion analysis data, including but not limited to coordinates of body joints and derived attributes used for further analysis.

The term “joint positions” refers to spatial coordinates or equivalent representations indicating the locations of anatomical reference points of a human body, such as shoulders, elbows, hips, knees, and ankles, in an image or motion sequence.

The term “joint angle information” refers to quantitative values representing angular relationships between pairs or sets of joint positions, used to characterize postural configuration of the human body.

The term “time-series change information” refers to information representing how feature information, joint positions, joint angles, or related metrics vary over time across multiple frames in the moving image data.

The term “motion evaluation information” refers to structured analysis data generated from feature information and time-series change information, including at least one of a work efficiency index and a safety index, and optionally additional indicators.

The term “work efficiency index” refers to a quantitative or qualitative measure indicating how effectively a user's motion achieves a task with respect to criteria such as unnecessary movement, smoothness, or time.

The term “safety index” refers to a quantitative or qualitative measure indicating a level of physical risk or potential for injury associated with a user's motion or posture.

The term “posture risk level” refers to a classification or numerical value derived from the motion evaluation information that represents a likelihood or severity of physical risk associated with a posture or motion segment.

The term “efficiency degradation level” refers to a classification or numerical value derived from the motion evaluation information that represents a degree of reduction in work efficiency in a motion segment compared to an efficient baseline.

The term “generative AI model” refers to a machine learning model, such as a generative language model, configured to generate natural-language text in response to input data and instructions.

The term “prompt sentence” refers to a text string or collection of text provided as input to the generative AI model, describing desired output characteristics and including at least a part of the motion evaluation information.

The term “natural-language text” refers to text data expressed in a human language, such as instructions, explanations, or recommendations, generated by the generative AI model.

The term “explanatory text” refers to a portion of natural-language text generated by the generative AI model that explains analysis results, motion characteristics, or detected issues in human-understandable terms.

The term “improvement proposal text” refers to a portion of natural-language text generated by the generative AI model that proposes specific changes or recommendations to improve a user's motion, safety, or efficiency.

The term “feedback information” refers to information for presentation to the user, including explanatory text, improvement proposal text, and optionally additional metadata, generated based on output from the generative AI model.

The term “presentation data” refers to data prepared for transmission to the user terminal, including feedback information and time-series information that associates the feedback with corresponding portions of moving image data.

The term “time-series information” refers to information indicating a temporal correspondence between analysis or feedback data and time intervals in the moving image data, such as timestamps or time ranges.

The term “playback position” refers to a time point or time range within the moving image data currently being reproduced or indicated in a media playback interface of the user terminal.

The term “dynamic modification” refers to a process in which the contents or structure of a prompt sentence or other data are automatically changed by the processor in response to motion evaluation information or system conditions.

The term “detailed improvement proposal text” refers to improvement proposal text that includes more granular or specific instructions, tailored to particular time intervals or posture conditions, compared to generic guidance.

The term “stepwise improvement proposal texts” refers to a plurality of improvement proposal texts generated across multiple iterations, each text building upon prior evaluation or feedback to support progressive refinement of the user's motion.

The term “iteration” refers to a cycle in which updated motion analysis or evaluation information is used to generate a new prompt sentence and to obtain new natural-language text from the generative AI model.

In one embodiment, a server cooperates with a terminal to implement the invention. The terminal includes at least one of a smartphone, a tablet, or a wearable display device such as smart glasses. The terminal includes a camera module, a display module, a local storage, a wireless communication module, and an onboard processor that executes a dedicated application. The server includes at least one general-purpose processor, a main memory, a non-transitory storage device, and a network interface, and executes multiple software modules including a video preprocessing module, a pose estimation module, a motion evaluation module, a prompt generation module, a generative AI interface module, and a feedback presentation data generation module.

The terminal uses a camera application implemented on a mobile operating system, for example using a camera framework such as CameraX on an open mobile platform or AVFoundation on a closed mobile platform, to capture a user's physical motion or work motion as moving image data. The terminal stores the captured data as compressed video files, for example in an H.264 or H.265 encoded MP4 container, in local flash storage. The terminal uses a communication library such as an HTTP client library to transmit the video files and related metadata (for example, user identifier, recording time, task type) to the server via a wireless network such as Wi-Fi or a cellular network.

The server receives the moving image data via a network interface and writes the video to a storage device. The server executes a video preprocessing program implemented, for example, with a multimedia processing library such as FFmpeg and an image processing library such as OpenCV. The server decodes the compressed bitstream into raw video frames and converts each frame into a unified pixel format and resolution (for example, RGB or BGR at 256×256 pixels). The server may perform normalization operations such as subtracting a mean value and dividing by a standard deviation per color channel to prepare the frames as motion analysis data. The server stores the motion analysis data in a structured data format, such as multi-dimensional arrays in memory, and associates each frame with a timestamp.

The server executes a pose estimation model on the motion analysis data. In one embodiment, the pose estimation model is a deep neural network of a convolutional neural network (CNN) and temporal convolutional network (TCN) or recurrent network type. The server uses a backbone network architecture, for example a stacked convolutional network with residual connections, to produce feature maps from each input frame. The server then applies a keypoint detection head that outputs heatmaps for each joint location (e.g., head, neck, shoulders, elbows, wrists, spine points, hips, knees, ankles). The server converts the heatmaps to joint coordinates using an argmax operation or soft-argmax operation. The server further executes a temporal modeling block, such as a temporal convolutional network or gated recurrent unit (GRU) sequence, that processes joint coordinates across multiple frames to reduce noise and capture motion patterns.

The server calculates joint angle information by computing angles at relevant joints using geometric relationships among detected joint coordinates. For example, the server computes a lumbar flexion angle by forming vectors between hip and shoulder joints and projecting these onto a vertical axis. Similarly, the server computes knee flexion angles from the relative positions of hip, knee, and ankle joints. The server also computes time-series change information such as angular velocity and duration during which angles exceed predetermined thresholds. The server stores, for each time interval, feature information including joint coordinates, joint angles, and derived temporal metrics.

The server executes a motion evaluation module that applies algorithmic rules and learned models to the feature information. In one embodiment, the server defines work efficiency indices using metrics such as trajectory smoothness, path length of the hands, unnecessary back-and-forth movement, and total motion time. The server may compute smoothness using jerk (third derivative of position) or frequency-domain analysis of joint trajectories. The server defines safety indices using metrics such as maximum lumbar flexion angle, duration of excessive flexion, degree of trunk rotation while under load, and stance stability based on foot positions and center-of-mass estimation. The server stores work efficiency indices and safety indices together as motion evaluation information, expressed as numerical scores, categorical levels (e.g., “low”, “medium”, “high risk”), and associated time segments.

The server constructs a prompt sentence for a generative AI model by converting the motion evaluation information into structured natural language. The server uses a prompt generation module that formats task type, key metrics, and target style instructions into a text string. For example, the server may generate a prompt sentence such as:

“You are an ergonomics and safety coach. Analyze the following worker motion and generate feedback about efficiency and safety. Task: lifting a heavy box from the floor. Analysis results: maximum lumbar flexion angle is 72 degrees, maximum knee flexion angle is 12 degrees, trunk twisting is present while the load is in the hands, and the duration of unsafe posture is 4.1 seconds. The efficiency score is low and the safety level is high-risk. Explain in simple language: (1) what the main risks are, (2) which parts of the motion are inefficient, and (3) step-by-step improvement methods that a factory worker can follow.”

The server then inputs the prompt sentence into a generative AI model via a generative AI interface module. The generative AI model may be implemented as a transformer-based neural network trained for natural-language generation. The server sends the prompt sentence as text to an external generative AI inference service or executes an on-premise neural network implemented in a framework such as TensorFlow or PyTorch. The generative AI model processes tokenized input using multiple attention layers and feed-forward layers with learned weights. The model outputs a sequence of tokens that represent natural-language text. The server decodes these tokens to generate explanatory text and improvement proposal text. The server may enforce constraints on maximum length, temperature, and style to ensure consistent output for industrial use.

The server generates feedback information by combining the explanatory text and the improvement proposal text with motion evaluation information. The server structures the feedback information as data fields including, for example, a title, a summary sentence, detailed explanations, bullet-pointed improvement steps, and references to specific time segments where issues occur. The server then generates presentation data that includes both the feedback information and time-series information that associates each feedback element with corresponding time intervals of the moving image data. The server may, for instance, maintain a mapping from time ranges (e.g., 2.0-3.5 seconds) to labels such as “excessive lumbar bending” and link these to specific sentences in the improvement proposal text. The server transmits the presentation data to the terminal. The terminal receives the data and uses a user interface framework (for example, Jetpack Compose on an open mobile platform or SwiftUI on a closed mobile platform) to display the video and corresponding feedback. The terminal may display a video playback timeline with markers for unsafe segments and show the relevant portion of the feedback text when playback reaches those segments. In a wearable display device, the terminal may overlay short textual hints, such as “bend your knees more” or “keep your back straighter,” synchronized with the user's view of the recorded motion. The terminal thus performs device-level display control based on the time-series information, which results in real-time or near-real-time alignment between motion visualization and feedback.

The server dynamically modifies the contents of the prompt sentence according to posture risk level and efficiency degradation level included in the motion evaluation information. When the server detects a time segment with high risk or severe inefficiency, the server adjusts the prompt sentence to request more detailed and focused guidance, for example: “For the high-risk segment between 00:02 and 00:04, the worker's lumbar flexion angle is about 70 degrees and the knees are almost straight. Provide very detailed instructions focused specifically on correcting this posture, including exact joint movements and easy-to-remember tips.”

For segments with low risk, the server may generate shorter, more general feedback, thereby reducing the number of tokens processed by the generative AI model and decreasing computation and communication overhead. This dynamic prompt control constitutes a non-conventional computational strategy, because the server uses machine-generated quantitative evaluation to adapt the structure and granularity of prompts, rather than statically forwarding the same type of query for all segments. As a result, the system improves computing resource utilization, response time, and output relevance.

The server also supports iterative improvement by reusing updated motion evaluation information after initial feedback has been presented. When the user performs a new motion recording after applying advice, the server compares the new motion evaluation information with prior results. The server then generates a prompt sentence that references changes across sessions, for example:

“Compare the worker's current lifting motion to the previous one. Previously, the maximum lumbar flexion angle was 72 degrees and the knees were almost straight. Now, the maximum lumbar flexion angle is 48 degrees and the knee flexion angle is 35 degrees. Explain what was improved, what still needs to be corrected, and give the next step of advice.” The server thereby causes the generative AI model to generate stepwise improvement proposal texts that guide progressive refinement. This iterative use of motion evaluation information within a controlled computational pipeline differs from merely repeating the same analysis, and it leads to a technical improvement in how the system manages historical data, generates context-aware prompts, and presents adaptive feedback.

In one embodiment, the server trains the pose estimation model and motion evaluation models using supervised machine learning. The server uses training datasets comprising annotated keypoints, joint angles, and safety labels. The server defines a loss function that may include a mean squared error component for keypoint positions, a cross-entropy loss for classification of unsafe events, and a regularization term to prevent overfitting. The server updates neural network weights using stochastic gradient descent or an adaptive optimization method. The server may apply data augmentation techniques such as random cropping, scaling, rotation, and temporal jittering to improve robustness to different camera angles and motion speeds. By explicitly specifying data augmentation and training procedures, the system achieves higher accuracy in posture detection and risk estimation compared to conventional systems relying on handcrafted rules or static templates.

The server uses specific data structures and processing flows to reduce communication load and improve response time. For example, the server may downsample video frames before pose estimation while retaining sufficient temporal resolution to capture key postures. The server may compute and store aggregated descriptors for each time segment (e.g., mean and maximum angles, risk flags) and send only compact motion evaluation information to the generative AI model, instead of sending raw video or high-dimensional feature maps. This design reduces the amount of data transferred between analysis modules and generative modules and results in an improvement in network bandwidth usage and latency.

The server may implement alternative embodiments of the generative AI model interaction. In one variant, the server locally hosts a smaller generative language model that is optimized for domain-specific feedback, thus reducing dependency on external services and improving privacy. In another variant, the server uses a hierarchical prompting strategy in which a first prompt requests a high-level summary of risks and a second prompt requests detailed instructions only for the most critical risk identified in the summary. By splitting the task into multiple targeted prompts, the system can achieve higher coherence and accuracy in feedback, which is a specific computational improvement over naive, single-prompt generation.

The terminal can vary in form factor. In one embodiment, the terminal is a smartphone used to record video and subsequently review feedback. In another embodiment, the terminal is a head-mounted display that records motion from the wearer's point of view and displays feedback in a semi-transparent overlay. In yet another embodiment, the terminal is a tablet placed on a stand near a work area, providing a larger screen for comparing multiple recordings. In each case, the terminal executes similar communication and display logic but may adapt the user interface layout and feedback presentation according to the display characteristics.

The system produces technical effects beyond mere automation of human analysis. The server transforms raw video signals into structured pose and motion representations, applies non-traditional, quantitative rules to derive dynamic prompt sentences, and controls the invocation of a generative AI model in a manner that optimizes computational resources and aligns feedback with real-time playback on constrained devices. Because the server uses precise, machine-computed metrics to determine where and how to apply high-resolution analysis and generation, the system reduces unnecessary processing, achieves faster feedback generation, and increases the precision and consistency of guidance. This improvement in data handling, model orchestration, and temporal alignment leads to an enhanced functioning of the computer system itself, rather than merely improving a human workflow.

In summary, the server executes a specifically structured sequence of image processing, pose estimation, motion evaluation, dynamic prompt generation, generative text production, and feedback alignment, using concrete data structures and model architectures. The terminal controls sensing and display functions to present the resulting feedback in a time-synchronized manner. Through these concrete hardware and software interactions, the system realizes a practical technical implementation that improves motion evaluation speed and accuracy, reduces communication and computation overhead, and enables iterative, fine-grained feedback that cannot be achieved by conventional manual or rule-based approaches.

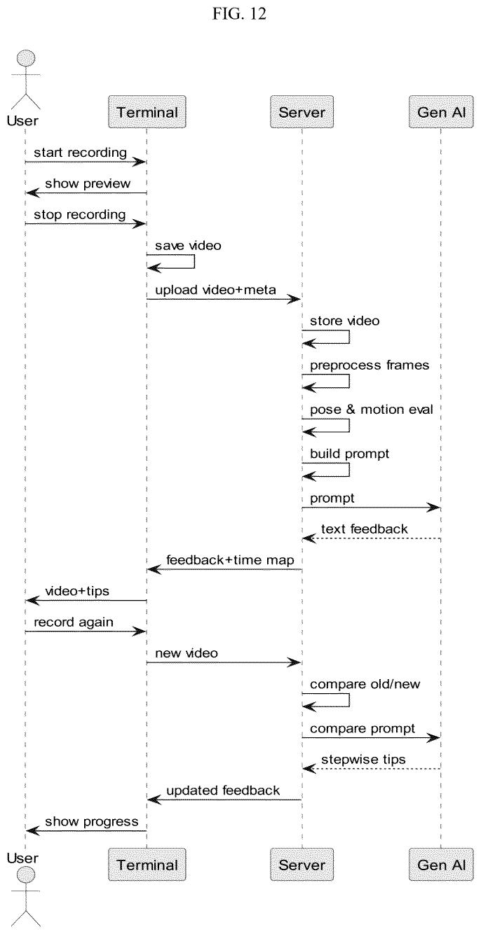

The following describes the processing flow using FIG. 12.

### Step 1

The user operates the terminal to capture motion video.

The user launches a dedicated application on the terminal and selects a recording mode corresponding to a specific task (for example, lifting, carrying, or pushing). The terminal activates a camera module using an operating system camera API and begins capturing a sequence of image frames and audio samples. The terminal encodes the captured frames into moving image data, for example as an H.264 stream in an MP4 container, and stores the resulting file in local storage together with metadata such as recording start time, task type, and user identifier.

Input: The input of this step is the user's physical motion in the real world and the user's selection of a recording mode on the terminal.

Output: The output of this step is moving image data and associated metadata stored in the terminal's local storage. The terminal performs data processing including sensor sampling, video encoding, and metadata tagging to convert continuous physical movement into discrete digital video and structured metadata.

### Step 2

The terminal uploads the moving image data to the server.

The terminal reads the recorded video file and metadata from local storage and constructs a network request using an HTTP client library. The terminal packages the video file as a binary payload and the metadata as structured fields and sends them to the server via a secure communication protocol over a wireless or wired network. The terminal may show an upload progress indicator and handle retransmissions if packet loss occurs.

Input: The input of this step is the moving image data file and metadata stored on the terminal.

Output: The output of this step is a transmitted data stream delivered to the server, consisting of video bytes and metadata. The terminal performs data operations including file reading, request construction, and network transmission to convert local file system data into a network-transferred payload.

### Step 3

The server receives and stores the moving image data.

The server listens on a network interface for incoming requests and, upon receiving the upload, parses request headers and body. The server writes the received video bytes into a storage device, generating a unique identifier for the video and associating the metadata with that identifier in a database. The server may verify file integrity by checking content length or computing a checksum.

Input: The input of this step is the uploaded data stream containing moving image data and metadata.

Output: The output of this step is a stored video file and a corresponding database record containing a video identifier and metadata. The server performs data processing including stream decoding from the network stack, file writing to persistent storage, and insertion of index information into a data table to make the video retrievable for later analysis.

### Step 4

The server preprocesses the video into motion analysis data.

The server loads the video file from the storage device using a multimedia processing library. The server decodes the compressed video into raw frames and extracts frames at a predetermined frame rate, for example 15 or 30 frames per second. The server resizes each frame to a fixed resolution and converts the pixel format to a representation required by the analysis models. The server normalizes pixel values, for example by scaling them to a 0-1 range or standardizing each channel, and composes the processed frames into arrays with associated timestamps.

Input: The input of this step is the stored video file identified by the video identifier.

Output: The output of this step is motion analysis data consisting of a sequence of normalized frames and timestamps. The server performs data operations including video decoding, frame sampling, geometric resizing, color conversion, and numerical normalization to transform compressed video into structured, model-ready arrays.

### Step 5

The server executes pose estimation on the motion analysis data.

The server passes batches of normalized frames to a pose estimation model implemented as a neural network. The server applies a convolutional backbone to compute feature maps for each frame, and then applies a keypoint prediction head that outputs heatmaps for multiple human joints. The server converts these heatmaps into joint coordinate vectors for each frame and optionally refines them using temporal smoothing, such as a temporal convolution or recurrent layer applied over sequences of frames.

Input: The input of this step is the motion analysis data consisting of normalized image frames with timestamps.

Output: The output of this step is feature information comprising joint positions and confidence scores for each frame and timestamp. The server performs data computations including convolution, non-linear activation, pooling, and soft-argmax or argmax operations to convert pixel-level data into high-level joint coordinate representations.

### Step 6

The server computes joint angles and time-series motion metrics.

The server receives joint positions over time and computes angles at specific joints using geometric formulas. For example, the server computes a lumbar flexion angle from vectors between hip and shoulder points, and knee flexion angles from hip, knee, and ankle points. The server calculates derivatives over time, such as angular velocity and angular acceleration, and identifies time intervals in which any angle exceeds defined safety thresholds. The server may accumulate statistics such as maximum angle values, average angles over task phases, and duration in unsafe regions.

Input: The input of this step is the sequence of joint positions with timestamps.

Output: The output of this step is joint angle information and time-series change information for each relevant joint and time interval. The server performs numerical computations including vector arithmetic, trigonometric functions, temporal differencing, and threshold comparison to derive quantitative posture and motion characteristics.

### Step 7

The server generates motion evaluation information including efficiency and safety indices. The server feeds joint angle information and time-series metrics into a motion evaluation module. The server computes work efficiency indices using algorithms such as path length of end-effectors, jerk-based smoothness measures, and task completion time. The server computes safety indices using rules and trained classifiers that assess maximum lumbar flexion, cumulative time above risk thresholds, trunk twist while under load, and stability-related metrics. The server maps these quantitative metrics to categorical levels such as “low risk”, “medium risk”, or “high risk” and assigns them to specific time segments.

Input: The input of this step is the joint angle information and time-series change information derived in the preceding step.

Output: The output of this step is motion evaluation information that includes numerical scores, categorical levels, and time-segment annotations for both efficiency and safety. The server performs data operations including metric aggregation, classification, risk-level mapping, and time-interval labeling to convert raw kinematic measures into interpretable evaluation structures.

### Step 8

The server constructs a prompt sentence for the generative AI model.

The server reads the motion evaluation information and converts it into a textual representation suitable for inclusion in a prompt. The server extracts key items such as task type, maximum angles, risk levels, unsafe durations, and efficiency scores, and formats them into a coherent description. The server embeds instructions regarding output style and level of detail. For example, the server may construct a prompt sentence such as:

“You are an ergonomics and safety coach. Analyze the following worker motion and generate feedback about efficiency and safety. Task: lifting a heavy box from the floor. Analysis results: maximum lumbar flexion angle is 72 degrees, maximum knee flexion angle is 12 degrees, trunk twisting is present while the load is in the hands, and the duration of unsafe posture is 4.1 seconds. The efficiency score is low and the safety level is high-risk. Explain in simple language: (1) what the main risks are, (2) which parts of the motion are inefficient, and (3) step-by-step improvement methods that a factory worker can follow.”

Input: The input of this step is the motion evaluation information including metrics and time segments.

Output: The output of this step is a prompt sentence expressed as a text string that encapsulates analysis results and instructions for the generative AI model. The server performs data operations including selection of salient metrics, textual formatting, and concatenation to transform structured numeric data into a structured natural-language input.

### Step 9

The server invokes the generative AI model and obtains natural-language feedback.

The server sends the prompt sentence to a generative AI model via a model interface module. The server tokenizes the text, submits the token sequence to a transformer-based network, and receives a sequence of output tokens. The server decodes these tokens into natural-language text, which includes explanatory text describing detected risks and patterns, and improvement proposal text listing concrete corrective actions. The server may set generation parameters such as maximum token length and randomness to control response characteristics.

Input: The input of this step is the prompt sentence generated in the previous step.

Output: The output of this step is natural-language text consisting of explanatory text and improvement proposal text. The server performs data computations including text tokenization, neural network inference, token sequence decoding, and post-processing to convert a structured textual request into a detailed language response.

### Step 10

The server dynamically refines prompt content for high-risk or low-efficiency segments.

The server examines the motion evaluation information to identify time segments with high posture risk level or high efficiency degradation level. For those segments, the server constructs additional or modified prompt sentences that request more detailed guidance focused on specific intervals and joints. For example, the server may generate a prompt such as:

“For the high-risk segment between 00:02 and 00:04, the worker's lumbar flexion angle is about 70 degrees and the knees are almost straight. Provide very detailed instructions focused specifically on correcting this posture, including exact joint movements and easy-to-remember tips.”

The server inputs these refined prompt sentences to the generative AI model and receives supplemental improvement proposal text targeted to the identified segments.

Input: The input of this step is the motion evaluation information, including risk and efficiency levels, together with initial generative output.

Output: The output of this step is additional, segment-specific improvement proposal text that has higher granularity for critical intervals. The server performs data operations including selection of critical time ranges, prompt restructuring, and secondary model inference, thereby adapting the amount and focus of generation to the computationally most relevant segments.

### Step 11

The server composes feedback information and aligns it with time segments.

The server combines explanatory text and improvement proposal text from initial and refined generations with motion evaluation information and time-series metadata. The server builds a data structure that associates each feedback item or sentence with one or more time intervals of the moving image data, for example linking “excessive lumbar bending” to the segment from 2.0 to 4.0 seconds. The server organizes the feedback into sections such as summary, main risks, and detailed steps.

Input: The input of this step is natural-language text from the generative AI model and the motion evaluation information including time-segment annotations.

Output: The output of this step is feedback information structured with textual content and time-indexed references. The server performs data operations including textual segmentation, time-interval mapping, and structural organization to turn raw generated text into a temporally aligned feedback specification.

### Step 12

The server generates presentation data and sends it to the terminal.

The server embeds the feedback information and the time-series correspondence information into a presentation data object, such as a JSON-like structure or equivalent representation. The server includes identifiers for relevant video segments, display labels, and ordering of feedback sections. The server transmits this presentation data to the terminal via the communication interface.

Input: The input of this step is the structured feedback information with associated time intervals.

Output: The output of this step is a transmitted presentation data payload that reaches the terminal. The server performs data operations including serialization, packaging into a response message, and network transmission to make the feedback available for user-side visualization.

### Step 13

The terminal displays synchronized video and feedback to the user.

The terminal receives the presentation data, parses the structure, and stores it in local memory. The terminal loads the corresponding video file (locally cached or streamed) and initializes a media player component. As the user plays, pauses, or scrubs through the video, the terminal uses the time-series correspondence information to determine which feedback items are relevant to the current playback position. The terminal updates on-screen text or overlay elements to show appropriate explanatory sentences and improvement instructions.

Input: The input of this step is the presentation data received from the server and the stored moving image data.

Output: The output of this step is a synchronized display of the video and feedback information on the terminal's screen or display module. The terminal performs data operations including parsing, time-based lookup, user-interface rendering, and event handling to transform data structures into real-time visual guidance.

### Step 14

The user reviews the feedback and performs a new motion attempt.

The user watches the video with synchronized feedback, reads the explanatory text and improvement proposal text, and internalizes the corrective guidance. The user then performs the task again, applying the suggested changes, and uses the terminal to record a new motion video.

Input: The input of this step is the displayed feedback and video on the terminal.

Output: The output of this step is a modified physical motion by the user, which becomes new moving image data when recorded. The user performs physical actions based on the feedback content, which creates new input conditions for subsequent analysis.

### Step 15

The server supports iterative improvement through updated analysis and prompts.

The server receives the new motion recording and repeats the analysis pipeline to produce updated motion evaluation information. The server compares the new metrics with previous session metrics and identifies improvements or remaining issues. The server then constructs a prompt sentence that explicitly refers to both old and new evaluation results, for example: “Compare the worker's current lifting motion to the previous one. Previously, the maximum lumbar flexion angle was 72 degrees and the knees were almost straight. Now, the maximum lumbar flexion angle is 48 degrees and the knee flexion angle is 35 degrees. Explain what was improved, what still needs to be corrected, and give the next step of advice.”

The server inputs this comparative prompt sentence into the generative AI model and obtains stepwise improvement proposal texts highlighting progress and next actions.

Input: The input of this step is the updated motion evaluation information from the new recording and the stored prior evaluation information from previous sessions.

Output: The output of this step is iterative, comparative feedback text that supports progressive refinement of the user's motion over multiple sessions. The server performs data operations including historical data retrieval, metric comparison, differential analysis, and comparative prompt construction to achieve a learning-oriented feedback loop.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional motion analysis and coaching systems largely rely on static rule-based algorithms or manually designed feedback templates executed on general-purpose computers. These systems typically apply fixed thresholds to sensor data or image data and then select prewritten messages, which results in several technical shortcomings from the standpoint of computer technology.

First, conventional systems do not automatically transform raw, heterogeneous image data of user motion into a standardized, machine-learning-ready representation in a way that is tightly integrated with subsequent feedback generation. Different resolutions, noise levels, and camera conditions often require manual tuning or separate preprocessing tools, which increases processing latency, consumes additional computing resources, and degrades the reliability of downstream analysis on the same computer platform.

Second, conventional systems commonly separate feature extraction, numerical evaluation, and text generation into loosely coupled modules without a unified data flow. The computer often executes feature extraction models and then performs only limited numeric comparisons, leaving the generation of feedback to static templates. As a result, the underlying processor does not exploit the rich structure of extracted feature data and evaluation data to guide adaptive, context-aware generation of analysis and suggestions, which leads to inefficient use of computing resources and rigid, low-quality output.

Third, when time-series usage is involved, conventional systems typically store only raw scores or summary labels without systematically linking those records to machine-generated explanations and visualizable structures. This makes it difficult for the computer to automatically compute and present improvement trends over multiple sessions in a coherent, machine-interpretable format. Consequently, additional ad hoc processing is required at the application layer, increasing system complexity and processing overhead.

Fourth, existing designs often treat the interaction with a generative AI model as a simple text-in/text-out operation, without programmatic construction of a structured prompt sentence that embeds motion-phase context, measured values, and reference values derived from numerical analysis on the same computing platform. This lack of structured prompt generation yields unstable or inconsistent responses from the generative AI model, forcing developers to manually adjust prompts and undermining the determinism and efficiency of the computer-implemented pipeline.

Therefore, there is a need for an improved computer-implemented system and server architecture that: (i) automatically executes integrated image preprocessing and pose-based feature extraction on a processor, (ii) computes motion angles and deviations against reference motion information within a unified data model, (iii) programmatically constructs structured prompt sentences that encode the computed evaluation information for a generative AI model, (iv) receives and structures the generative output as feedback information linked to the numeric evaluation, and (v) manages these results as time-series data to compute and present improvement states, thereby improving the technical functioning of the computer system as a whole in terms of data handling, processing efficiency, and quality of machine-generated feedback.

The specific processing by the specific processing unit 290 of the data processing device 12 in Example 2 is realized by the following means.

The present invention provides a server comprising a processor configured to control an information terminal having an imaging function and a network communication function so as to acquire image information including a user's physical motion or work motion and to cause the information terminal to transmit the image information to the server; to perform, on the server, preprocessing on the image information by using an image processing program to normalize pixel information, unify resolution, reduce noise components, and convert the image information into an input format for machine learning; to execute, by using a machine learning program, feature extraction processing on the preprocessed image information so as to obtain feature data indicating joint positions, postures, and arrangements of body portions of a subject, and to calculate limb angles, trunk angles, posture inclinations, and motion trajectories on the basis of the feature data; to generate evaluation information indicating motion efficiency, angle deviation, and posture deviation by comparing the calculated angle information and posture information with reference motion information stored in a storage device; to automatically generate, on the basis of the evaluation information and the feature data, a structured prompt sentence including at least a motion target, a motion phase, measured values, and reference values, and to input the prompt sentence to a generative information processing model so as to cause the generative information processing model to generate analysis content and improvement proposals expressed in natural language; to associate the analysis content and the improvement proposals output from the generative information processing model with the evaluation information to structure the associated information as feedback information, to generate display data including at least one of text information and graphic information from the feedback information, and to transmit the display data to the information terminal; and to store and manage, in a time-series manner, the feedback information and past feedback information such that they are retrievable in response to operation information from the information terminal, and to generate information indicating an improvement state on the basis of changes in evaluation information at a plurality of time points. This enables the server to implement an integrated, computer-optimized processing pipeline in which heterogeneous image data is automatically standardized for machine learning, pose and angle features are numerically evaluated against stored references, structured prompt sentences are programmatically constructed for a generative AI model, and time-series feedback information is generated and managed, thereby improving processing efficiency, consistency of generative output, and the overall technical performance of the motion analysis system executed by the server.

The term “system” refers to a combination of hardware and software components including at least one processor, at least one memory, at least one communication interface, and at least one information terminal, which cooperate to execute the claimed processing. The term “processor” refers to a hardware processing unit, such as a central processing unit or a graphics processing unit, or a combination thereof, configured to execute instructions stored in a memory to perform the functions described in the claims.

The term “information terminal” refers to an electronic device having at least an imaging function, a display function, a user input function, and a network communication function, such as a mobile communication device, a portable computing device, or a stationary computing device.

The term “imaging function” refers to a capability of an information terminal or another device to capture image information, including still images or moving images, using an image sensor such as a solid-state imaging sensor.

The term “network communication function” refers to a capability of an information terminal or another device to transmit and receive data over a communication network using a wired or wireless communication interface.

The term “image information” refers to digital data representing visual information, including at least one image frame or a sequence of image frames, which may include a user's physical motion or work motion.

The term “physical motion” refers to a movement of at least a part of a user's body, including a posture change, a limb movement, or a body translation, captured as image information. The term “work motion” refers to a movement performed by a user in association with a task or operation, including industrial work, sports performance, or training activity, captured as image information.

The term “information processing apparatus” refers to a computing apparatus, such as a server device or a cloud computing resource, including at least one processor and at least one memory, configured to execute the processing described in the claims.

The term “image processing program” refers to a set of instructions executed by a processor to perform operations on image information, including at least pixel value normalization, resolution conversion, and noise reduction.

The term “normalize pixel information” refers to adjusting pixel values of image information to a standard scale, range, or distribution suitable for machine learning input.

The term “unify resolution” refers to converting image information to a predetermined spatial size or pixel count so that multiple images share a common resolution.

The term “reduce noise components” refers to applying computational operations to image information to attenuate unwanted variations, artifacts, or random disturbances in pixel values.

The term “input format for machine learning” refers to a digital representation, such as a numeric array or tensor, structured to be compatible with an input interface of a machine learning program or model.

The term “machine learning program” refers to a set of instructions, including a trained model and inference logic, executed by a processor to perform pattern recognition, feature extraction, or prediction based on input data.

The term “feature data” refers to numerical or symbolic data representing extracted characteristics from image information, including positions, orientations, or configurations of body portions of a subject.

The term “joint positions” refers to coordinate information indicating estimated locations of anatomical joints, such as shoulders, elbows, hips, knees, or ankles, in an image space or a transformed coordinate system.

The term “postures” refers to configurations of a subject's body, including relative orientations, alignments, and angles of body segments inferred from joint positions or other features.

The term “arrangements of body portions” refers to spatial relationships among multiple body segments or body parts, such as distances, relative angles, or relative positions, derived from feature data.

The term “limb angles” refers to angular values representing bending or orientation of limbs, such as arms or legs, computed from positions of corresponding joints.

The term “trunk angles” refers to angular values representing orientation or inclination of a torso or spine portion of a subject relative to a reference direction or reference plane.

The term “posture inclinations” refers to angular deviations of the overall body posture or a body segment from a predetermined reference axis, such as vertical or horizontal.

The term “motion trajectories” refers to paths or sequences of positions of one or more body parts over time, represented as curves or ordered coordinate sets.

The term “reference motion information” refers to data stored in a storage device that represents desired or ideal motion patterns, angle values, posture values, or allowable ranges used as a comparison standard.

The term “storage device” refers to a non-transitory computer-readable medium, such as a semiconductor memory, magnetic storage, or optical storage, that stores programs, parameters, or data including reference motion information.

The term “evaluation information” refers to information generated by a processor that quantifies or qualifies motion characteristics, including motion efficiency, angle deviation, and posture deviation.

The term “motion efficiency” refers to a measure indicating how effectively or smoothly a motion is performed, based on computed features, angle relationships, or temporal characteristics.

The term “angle deviation” refers to a difference between a computed angle related to a user's motion and a corresponding reference angle derived from reference motion information.

The term “posture deviation” refers to a difference between a computed posture characteristic of a user and a corresponding reference posture characteristic derived from reference motion information.

The term “prompt sentence” refers to a text string or structured textual representation generated by a processor, including at least information about a motion target, a motion phase, measured values, and reference values, and supplied as input to a generative information processing model.

The term “motion target” refers to a description of a specific motion or action to be analyzed or improved, such as a particular sport motion or work activity.

The term “motion phase” refers to a temporal or functional segment of a motion, such as preparation, execution, or follow-through, identified for analysis.

The term “measured values” refers to numeric or symbolic values computed from feature data, including angles, positions, or other motion-related metrics.

The term “reference values” refers to numeric or symbolic values derived from reference motion information used as standards for comparing measured values.

The term “generative information processing model” refers to a computational model, such as a generative artificial intelligence model or a language model, configured to generate text or other data in response to an input prompt.

The term “analysis content” refers to generated text or structured information produced by a generative information processing model that explains or interprets motion characteristics or deviations.

The term “improvement proposals” refers to generated text or structured information produced by a generative information processing model that suggests one or more corrective actions or training methods based on analysis content.

The term “feedback information” refers to information structured by a processor that associates evaluation information with analysis content and improvement proposals for presentation to a user.

The term “display data” refers to data generated by a processor for rendering on a display, including at least one of text information and graphic information derived from feedback information.

The term “text information” refers to character-based data, such as sentences or labels, suitable for display in a textual format.

The term “graphic information” refers to visual elements such as lines, shapes, icons, or overlays, representing motion-related information, evaluation results, or guidance on an image or graphical interface.

The term “operation information” refers to input data generated by a user's operation on an information terminal, including commands, selections, or navigation actions related to analysis results.

The term “time-series manner” refers to storing or managing data with an association to chronological ordering or timestamps so that changes over multiple time points can be determined.

The term “improvement state” refers to information indicating progression, regression, or stability of a user's motion characteristics over time, derived from changes in evaluation information at a plurality of time points.

The term “fee information” refers to data representing a charge or price associated with usage of the system, including information regarding a single-use fee.

The term “settlement information” refers to data used to execute payment processing, including payment method information, authorization data, or transaction identifiers.

The term “billing processing” refers to a series of operations performed by a processor to accept fee information and settlement information, to execute payment, and to control user access rights for the system based on payment status.

The term “usage rights” refers to permissions granted to a user to access or utilize one or more functions or services of the system.

The term “registration information” refers to data associated with user enrollment for continuous or subscription-based use, including user identifiers, contact details, or plan types. The term “contract information” refers to data representing terms and conditions of a usage agreement, including contract duration, renewal conditions, and service levels.

The term “subscription management processing” refers to operations performed by a processor to manage registration information and contract information and to control usage rights and service provision conditions for continuous use of the system.

The term “service provision conditions” refers to parameters defining how and to what extent services of the system are made available to a user, including limitations on features, frequency of analysis, or data retention.

In one embodiment, a server cooperates with an information terminal and a user to implement the claimed system. The server includes at least one central processing unit (CPU), at least one graphics processing unit (GPU), a main memory, a non-transitory storage device, and a network interface. The server executes application software implemented, for example, using a general-purpose operating system, a web application framework, an image processing library such as OpenCV, and a machine learning framework such as TensorFlow or PyTorch. The terminal includes a processor, a memory, an imaging device such as a solid-state imaging sensor, a display, input components such as a touch panel, and a wireless or wired communication interface. The user operates the terminal to capture motion scenes and to view analysis results.

The terminal records a motion scene of the user by controlling the imaging device. The terminal executes camera control software, for example, an operating-system camera API, to set parameters such as frame rate, exposure, and resolution, and to acquire image frames. The terminal converts the raw sensor output into compressed image data in a standard image format such as JPEG or PNG. The terminal associates metadata, such as capture time, shooting angle (e.g., “side view”), and motion type (e.g., “golf swing”), with the image data in a structured record in a local memory. The terminal then transmits the image data and the metadata to the server through a network using a communication protocol such as HTTPS. The server receives the image data through a network interface controlled by server-side application software. The server stores the raw image data and the attached metadata in a storage device, for example, in a directory or in a database record. The server assigns an identifier to each uploaded sample so that subsequent processing modules can refer to the same data structure. The server represents each image as a multidimensional numeric array in memory, using a numerical computation library, for example, a tensor data type with dimensions corresponding to height, width, and color channels.

The server applies an image processing library such as OpenCV to normalize pixel information, unify resolution, and reduce noise components. The server converts color channels into a consistent color space, resizes each image to a fixed dimension such as 512 by 512 pixels using interpolation, and applies a smoothing filter such as a Gaussian blur to attenuate random noise. The server then scales pixel values into a predefined numeric range such as [0, 1] or a mean-zero, unit-variance distribution. By performing these operations, the server converts heterogeneous image inputs into a standardized tensor representation optimized for subsequent machine learning inference, thereby reducing the need for manual pre-tuning and decreasing error rates caused by uncontrolled variation in raw images. The server executes a machine learning framework such as TensorFlow or PyTorch on the GPU to perform pose estimation and feature extraction. In one embodiment, the server loads a convolutional neural network (CNN) model that includes a series of convolutional layers, non-linear activation layers, pooling layers, and fully connected layers. The server may employ an architecture similar to a multi-stage pose estimation network in which a feature extraction backbone (for example, a residual network) produces a feature map, and a head network outputs two-dimensional confidence maps and part affinity fields for anatomical keypoints. The server feeds the standardized image tensor to this CNN and computes, for each candidate joint (e.g., head, shoulder, elbow, wrist, hip, knee, ankle), a probability distribution over spatial positions. The server selects joint coordinates by applying an argmax operation on the confidence maps and calculates joint positions as pairs of coordinates in the image plane.

The server calculates limb angles, trunk angles, and posture inclinations from the joint positions. The server represents each limb as vectors between joints (for example, shoulder-elbow and elbow-wrist vectors for an arm). The server computes angles using vector dot products and inverse trigonometric functions implemented by a numerical library.

The server calculates a spine angle by approximating the trunk using a vector connecting a hip joint to a shoulder joint. The server optionally approximates motion trajectories by combining multiple frames and computing time-ordered sequences of joint positions. By representing motion as a collection of numeric features in a defined coordinate system, the server creates a machine-interpretable description that can be processed algorithmically without manual interpretation.

The server compares computed angles and postures with reference motion information stored in a storage device. The server stores reference motion information as tables of ideal angle ranges and posture profiles for each motion type and motion phase. For example, for a golf downswing, the server stores an ideal incident angle range relative to a target line, a range of acceptable spine angles, and a desired hip rotation value. The server executes comparison logic on the CPU to compute, for each metric, a deviation value defined as a difference between the measured value and the corresponding reference value or reference range. The server represents these deviations and the original measurements as evaluation information in a structured record, for example, a set of key-value pairs linking each body segment or metric to its measured value and deviation.

The server then constructs a prompt sentence for a generative AI model. The server does not simply forward raw numeric data; instead, the server executes a formatting procedure that converts evaluation information into a structured, human-readable text string that includes explicit labels for motion target, motion phase, measured values, and reference values. For example, the server generates a prompt sentence such as:

“Sport: golf. Motion phase: downswing and impact as seen from a side view. Measured incident angle of the club: 5 degrees to the right of the ideal target line. Measured spine forward tilt: 7 degrees greater than the reference posture. Measured hip rotation: 10 degrees less than the ideal rotation. Analyze these measurements, explain what is wrong with the user's swing, and provide step-by-step, practical advice for correcting the incident angle and posture.”

In another example, the server generates a beginner-oriented prompt sentence such as: “Analyze a beginner golfer's swing from this data: club incident angle is 5 degrees right of the target line, spine tilt is 7 degrees too far forward, and hip rotation is 10 degrees too small compared with the ideal model. In very simple terms, explain the main problems and give three easy practice tips to fix them.”

By injecting structured numerical context into the prompt sentence, the server constrains the generative AI model to produce analysis that is consistent with the computed metrics, thereby improving determinism and reducing variability compared with naïve free-form prompting. The server executes a generative AI model on a computing platform or through an application programming interface. In one embodiment, the server uses a large-scale language model implemented as a deep neural network with multiple transformer layers, attention mechanisms, and learned token embeddings. The server provides the prompt sentence as an input sequence of tokens. The generative AI model applies self-attention and feedforward computations to predict successive output tokens conditioned on the input and preceding output, thereby producing an analysis content and improvement proposals expressed in natural language. The server receives this text output and parses it into logical sections, such as a summary of issues and a list of recommendations, using delimiters or pattern recognition routines.

The server associates the generative analysis content and improvement proposals with the evaluation information. The server constructs feedback information as a multi-field data structure that binds each narrative explanation to the underlying quantitative metrics. For example, the server links a statement such as “your club is approaching from outside-in” to a measured incident angle deviation of 5 degrees to the right. This association enables the server to create display data that simultaneously shows numeric errors and verbal guidance, and enables later aggregation across sessions. The server formats the feedback information into display data suitable for rendering on the terminal, including textual content and optional graphics such as lines overlaying the original image to indicate ideal and actual angles. The server sends the display data to the terminal over the network.

The terminal receives the display data and renders it on the display. The terminal uses a graphical user interface framework to layout text in readable form and to draw graphical overlays or charts. The terminal may display, for example, the original motion image with two colored lines indicating the target line and the actual club path, along with captions describing the deviation, such as “incident angle +5° right” and “spine tilt +7° forward.” The user visually compares these indicators and reads the recommended corrections. The user then adjusts their motion accordingly in the real world.

The server stores feedback information for each session along with timestamps in a storage device. The server manages these records in a time-series manner, enabling retrieval of historical data. The server computes an improvement state by comparing evaluation information across multiple sessions, for example, by tracking a reduction in angle deviations or posture deviations over time. The server may aggregate these changes into summary variables such as an improvement score. The server then generates overview display data that shows trends, such as a graph indicating that the user's incident angle deviation gradually decreased from 10 degrees to 2 degrees over several practice sessions.

The system provides several technical effects that go beyond mere automation of human judgment. The server transforms raw, device-dependent image data into a machine-normalized tensor representation that is specifically optimized for pose estimation models, thereby improving the reliability of downstream computations on the same hardware. The server integrates feature extraction, numerical evaluation, structured prompt sentence generation, generative text production, and time-series analysis into a coherent data pipeline. Because each module operates on defined data structures and passes precisely defined feature and evaluation fields, the server can reduce redundant computations and avoid error-prone conversions, thereby improving processing speed and reducing resource usage.

The use of a CNN-based pose estimation model on GPU hardware allows the server to infer joint positions and angles at a higher accuracy and throughput than manual frame-by-frame annotation. In addition, by training the pose estimation model on augmented datasets that include variations in lighting, clothing, and camera angles, the server can maintain robust performance even under noisy real-world conditions. Data augmentation techniques such as random rotation, scaling, horizontal flipping, and color jittering are applied during model training so that the trained weights generalize to diverse input conditions, reducing the rate of misdetections on the running system.

The generative AI model is not used as a black box making unexplained judgments. Instead, the server constrains the input to the model with precisely structured prompt sentences that encode the output of deterministic numeric processing. This division of labor allows complex natural-language explanations to be produced while ensuring that the underlying numeric conclusions are computed by explicit algorithms under the server's control. As a result, the system improves consistency of output and reduces errors attributable to free, unconstrained language generation. Furthermore, by managing feedback and evaluation data as linked entities in a time-series structure, the server enables efficient retrieval and computation of improvement states without reprocessing past image data, thereby reducing computation load and network traffic.

The system adopts processing rules and data flows that differ from conventional human-centered analysis. The server automatically calculates joint-based metrics in a high-dimensional vector space, uses comparative thresholds and reference ranges that are not readily applied by humans in real time, and programmatically merges these metrics into structured prompt sentences. The generative AI model is forced to respect these numeric constraints, resulting in an integrated decision-making pipeline that a human coach cannot reproduce at comparable speed or scale. This architecture improves the computer's technical performance by optimizing use of CPU and GPU resources, minimizing redundant data conversions, and providing repeatable, high-precision motion evaluation.

In another embodiment, the server may employ an alternative neural network architecture, such as a lightweight mobile-oriented CNN, a graph convolutional network operating on joint graphs, or a transformer-based vision model, to extract body features. The server may also store reference motion information per user class (e.g., beginner, intermediate, advanced) and dynamically select appropriate reference ranges according to user metadata, thereby improving accuracy and personalization. In a further embodiment, the server may perform on-device preprocessing or inference on the terminal when sufficient computational resources are available, thereby reducing network bandwidth usage by transmitting only extracted features instead of full images. These variations maintain the same fundamental data structures and processing steps while allowing adaptation to different hardware environments.

In another variation, the server configures the generative AI model to output not only natural-language text but also structured tags indicating which joints or metrics are most critical to correct. The server can then emphasize these in the display data by, for example, color-coding the most deviated joints. Because these tags are computed based on the same evaluation information and prompt sentence context, the system improves usability of the feedback while maintaining the underlying technical advantages of the integrated processing pipeline.

By implementing the above embodiments, the server, the terminal, and the user cooperate in a technical interaction that converts raw sensor-level image data into standardized machine-learning inputs, performs pose and angle calculations using specialized neural network architectures and numeric algorithms, constructs structured prompt sentences that encode these numeric evaluations, and produces linked, time-series feedback data. This configuration improves calculation accuracy, processing speed, and data management efficiency of the motion analysis system as executed by the computer hardware, and thereby realizes technical effects that extend beyond a mere automation of human mental processes.

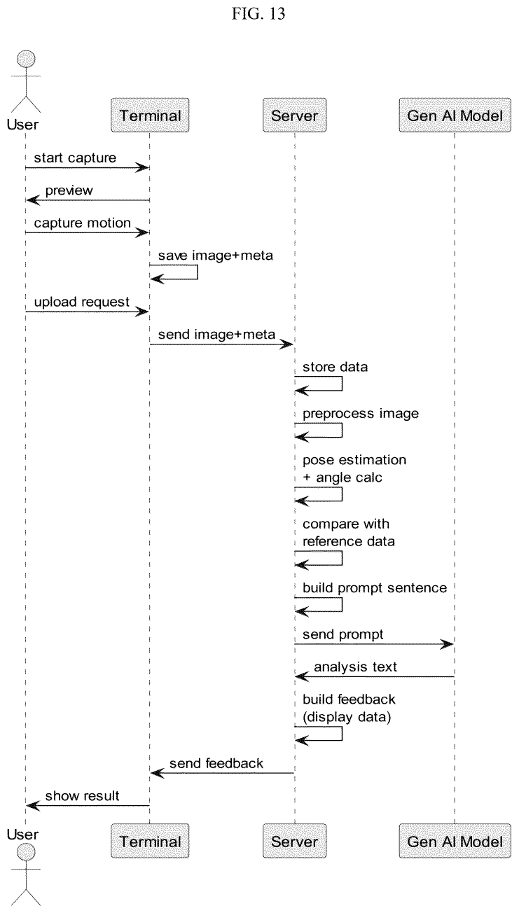

The following describes the processing flow using FIG. 13.

### Step 1

The user operates the terminal to capture a motion scene. The user launches an application on the terminal, selects a motion analysis mode (for example, “golf swing” or “work posture”), and positions the terminal so that the camera faces the user. The terminal activates the imaging device, displays a live preview, and waits for user input. When the user presses a capture or record button, the terminal acquires one or more frames from the image sensor.

Input: Raw sensor signals from the imaging device and user operation information (capture command, selected motion type, camera angle).

Output: Compressed image data (for example, JPEG or PNG files) and associated metadata (for example, timestamp, motion type, camera orientation) stored in the terminal's local memory. The terminal converts the sensor signals into digital image frames, encodes them in a standard image format, and creates a metadata record linked to each image.

### Step 2

The terminal transmits the captured image data to the server. The user confirms that the captured scene is acceptable and taps an “Upload and Analyze” button. The terminal reads the image file and metadata from local memory and builds a network request using an HTTP client library. The terminal attaches the binary image data and metadata fields (motion type, camera view, user identifier) as parameters in an HTTPS POST request.

Input: Local image files and metadata stored on the terminal, plus the user's explicit upload command.

Output: A network message containing the image data and metadata sent over the communication network to the server. The terminal performs data packaging (for example, multipart/form-data encoding), adds headers, and initiates the secure connection to transfer the data.

### Step 3

The server receives and stores the uploaded data. The server's network interface accepts the HTTPS request and passes it to a web application module. The server parses the request to extract the image bytes and metadata, assigns a unique sample ID, and writes the raw image data to a storage device. The server also stores the metadata and the sample ID in a database or management table.

Input: Network request containing image data and metadata transmitted from the terminal.

Output: Persisted raw image file in server storage and a structured record (sample ID, file path, metadata) registered in a management data structure. The server thus transforms transient network data into durable storage entries that can be accessed by subsequent processing modules.

### Step 4

The server performs image preprocessing to normalize the data for machine learning. The server loads the image file from storage into memory and represents it as a multidimensional array using an image processing library. The server converts the color space if necessary, resizes the image to a fixed resolution (for example, 512×512 pixels), and applies a noise reduction filter (for example, Gaussian blur) to smooth high-frequency artifacts. The server then scales pixel values into a standardized numeric range and may perform cropping or padding to maintain aspect ratios.

Input: Raw image data (file path or binary) and associated metadata (original resolution, color format).

Output: A preprocessed image tensor with standardized dimensions and normalized pixel values. The server executes explicit numeric operations, such as interpolation for resizing and convolution for blurring, to transform the raw pixels into a consistent input format for later neural network inference.

### Step 5

The server executes a pose estimation model to extract feature data. The server passes the preprocessed image tensor into a machine learning framework running a trained convolutional neural network. The server performs forward propagation through convolutional, activation, pooling, and output layers to generate joint confidence maps and part affinity fields. The server then applies an argmax or peak-finding algorithm over the confidence maps to determine the coordinates of key joints, such as head, shoulders, elbows, hips, knees, and ankles. The server may apply post-processing to enforce skeletal consistency, such as connecting joints that maximize confidence and alignment.

Input: Preprocessed image tensor.

Output: Feature data consisting of joint positions and related confidence scores, represented as arrays of (x, y, confidence) tuples for each detected joint. The server transforms pixel intensity patterns into high-level pose descriptors by applying learned convolutional filters and non-linear operations defined in the model.

### Step 6

The server computes angles, postures, and motion metrics from the feature data. The server selects triplets of joints to define limb segments, such as shoulder-elbow-wrist for an arm or hip-knee-ankle for a leg, and constructs vectors between joints. The server calculates angles using dot products and inverse cosine operations on these vectors. The server computes trunk angles by using vectors between hip and shoulder joints and determines posture inclination relative to a vertical axis. If multiple frames are available, the server orders the joint positions by time and computes motion trajectories as sequences of coordinates.

Input: Joint position data and confidence scores produced by the pose estimation model.

Output: Numeric motion metrics, including limb angles, trunk angles, posture inclinations, and optionally motion trajectories. The server performs explicit geometric computations to translate joint coordinates into scalar angle values and trajectory descriptors.

### Step 7

The server evaluates motion by comparing measured metrics with reference motion information. The server retrieves reference angle ranges and posture parameters from a storage device according to the motion type and motion phase indicated by the metadata. The server calculates deviations by subtracting reference values from measured values or by determining whether measured values fall outside reference ranges. For each metric, the server computes quantities such as angle deviation, posture deviation, and estimated motion efficiency metrics derived from multiple angles.

Input: Measured motion metrics (angles, postures, trajectories) and reference motion information (ideal angles, acceptable ranges).

Output: Evaluation information that numerically describes motion efficiency, angle deviations, and posture deviations. The server generates structured records where each field corresponds to a particular metric and contains measured value, reference value, and deviation.

### Step 8

The server generates a structured prompt sentence for a generative AI model. The server reads the evaluation information and feature data and constructs a text string that encodes the motion target, motion phase, measured values, and reference values using a predefined template. The server inserts numeric values into labeled positions in the text and may adjust wording based on user level or analysis purpose. For example, the server generates a prompt sentence such as:

“Sport: golf. Motion phase: downswing and impact as seen from a side view. Measured incident angle of the club: 5 degrees to the right of the ideal target line. Measured spine forward tilt: 7 degrees greater than the reference posture. Measured hip rotation: 10 degrees less than the ideal rotation. Analyze these measurements, explain what is wrong with the user's swing, and provide step-by-step, practical advice for correcting the incident angle and posture.”

Input: Evaluation information, feature data, and motion metadata.

Output: A text prompt sentence that includes structured, labeled descriptions of metrics and deviations. The server performs string formatting and template filling operations to convert numerical and symbolic internal data into a coherent natural-language instruction for the generative AI model.

### Step 9

The server obtains natural-language analysis and improvement proposals from the generative AI model. The server sends the constructed prompt sentence to a generative information processing model via an application programming interface or an internal model serving interface. The server encodes the prompt as input tokens, sets model parameters (such as maximum output length or style), and requests generation. The generative AI model processes the prompt and outputs a sequence of tokens representing analysis content and recommendations. The server receives this output and converts tokens back into text.

Input: Prompt sentence provided by the server and configuration parameters for the generative AI model.

Output: Generated natural-language text including analysis content and improvement proposals. The server acts as a controller that feeds precise, structured information into the model and retrieves the generated response for further processing.

### Step 10

The server structures the feedback information and prepares display data. The server parses the generated text to identify logical units, such as a summary section and a list of recommended actions, by looking for line breaks, bullet markers, or textual markers. The server associates each segment of analysis with relevant evaluation metrics, for example, linking a comment about spine tilt directly to the spine angle deviation value. The server then creates a feedback information record containing both numeric fields and textual fields. The server generates display data that includes text elements and, when available, coordinates for graphical overlays (such as lines representing the ideal and actual swing paths).

Input: Generated natural-language text and evaluation information.

Output: Display data structured for transmission to the terminal, including feedback information that combines numeric metrics, textual explanations, and optional graphics parameters. The server performs data aggregation and formatting operations to transform separate numeric and text sources into a single, presentation-ready data structure.

### Step 11

The server transmits the display data and stores the session data for time-series analysis. The server sends the display data to the terminal via the network using a response message.

Simultaneously, the server writes the evaluation information, prompt sentence, generative AI output, and derived feedback information to a storage device with an associated timestamp and sample ID. The server indexes this session record so that it can be retrieved later for comparison with other sessions.

Input: Feedback information and display data generated by the server, as well as session identifiers and timestamps.

Output: Network response containing display data delivered to the terminal, and persistent records in storage representing the full analysis session, including metrics, prompt, and generated feedback. The server thus converts transient processing results into durable, queryable time-series data.

### Step 12

The terminal presents the feedback to the user. The terminal receives the display data from the server, parses the structured content, and renders it on the display using a user interface framework. The terminal shows textual feedback, such as “Your club's incident angle deviates 5 degrees to the right, and your torso is tilted 7 degrees too far forward,” and may draw graphical overlays on the original image using provided coordinates. The user visually inspects these indicators and reads the recommendations.

Input: Display data from the server containing textual and graphical presentation elements.

Output: A rendered screen showing combined visual and textual feedback to the user. The terminal performs graphical composition and text layout operations to convert abstract display data into pixels on the screen that convey the analysis results and suggested improvements.

### Step 13

The user reviews the feedback and optionally initiates new analysis sessions. The user interprets the numeric and textual feedback, adjusts physical motion or posture according to the recommendations, and decides whether to perform another motion attempt. If the user chooses to repeat, the user again uses the terminal to capture a new motion scene and restarts the process.

Input: Feedback displayed on the terminal and the user's current physical performance and goals.

Output: A new user action, such as repeating a motion under adjusted conditions or terminating the session. The user's response provides new input scenes that, when captured by the terminal and analyzed by the server, contribute to the time-series data used to evaluate long-term improvement.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional motion-analysis and coaching systems typically execute separate pipelines for kinematic analysis and emotion recognition, if emotion is considered at all. In many implementations, a fixed, rule-based analysis module computes angles and posture metrics offline, and a separate analytics module periodically generates static reports. Such architectures suffer from multiple technical limitations when deployed on general-purpose computing hardware.

First, these systems do not tightly integrate motion feature extraction, emotion estimation, and feedback generation within a single, coherent processing loop executed by a processor. As a result, the processor often performs redundant data access and repeated feature computation across different modules, which increases memory bandwidth usage and processing latency. This makes it difficult to provide real-time feedback on commodity computing platforms, especially when processing high-resolution video and audio streams from multiple users.

Second, many existing systems use generative AI models in an ad-hoc manner, for example by manually crafting input text for a model that is loosely coupled to the underlying motion measurements. In such systems, the processor does not systematically construct prompt sentences based on structured motion feature data and emotion states. Consequently, the generative AI model cannot reliably exploit fine-grained, time-series information such as joint trajectories or emotion transitions. This leads to low precision and instability in generated feedback, as the model receives incomplete or poorly structured input.

Third, conventional server-side architectures frequently treat emotional signals as optional metadata and do not maintain a unified time-series record of motion performance and emotional state per user and per session. Without such a persistent, structured record, the processor cannot efficiently evaluate user progress or adapt future feedback generation. This results in repetitive and non-adaptive responses, increases the amount of data that must be reprocessed for each session, and wastes computational resources.

Fourth, when systems are extended with billing or subscription features, such processing is often implemented in a separate service that is unaware of the internal analysis workflow. This separation can cause inconsistent accounting of actual computational load and network usage. For example, billing may be based only on session count, without regard to the number of feedback generations or progress evaluations actually performed by the processor. This mismatch reduces the efficiency of resource allocation and can result in over- or under-utilization of computing infrastructure.

Therefore, there is a need for an improved computer-implemented system and method in which a processor: (i) controls acquisition and transmission of motion data, (ii) extracts motion features in a time-series manner, (iii) cooperates with a generative AI model through dynamically constructed prompt sentences that encode both motion analysis results and emotion states, (iv) provides real-time feedback at the terminal, and (v) persistently records motion performance and emotional state to evaluate progress, while supporting accurate usage-based or subscription-based charging. Such an architecture should improve latency, throughput, and relevance of feedback on general-purpose computing hardware, thereby improving the functioning of the computer system itself when executing motion-analysis and coaching workloads.

The specific processing by the specific processing unit 290 of the data processing device 12 in Application Example 2 is realized by the following means.

The present invention provides a server comprising a processor configured to control an image acquisition unit that acquires a user's physical motion or work motion, control a communication unit that transmits moving image data or still image data acquired by the image acquisition unit, analyze, via an image processing unit, moving image data or still image data received via the communication unit to extract feature point information of a target object and generate motion feature data indicating motion efficiency, angles, and posture deviation by generating posture change information along a time axis based on the feature point information, input the motion feature data and attribute information associated with the moving image data or the still image data as input information, input a prompt sentence that defines an analysis purpose and an output format to a generative AI model as a generative information processing model, and generate analysis result data including an evaluation result of the motion feature data by using the generative AI model, extract a face region and an audio signal from the moving image data or the still image data and estimate an emotional state of the user based on the face region and the audio signal, dynamically construct, based on the analysis result data and the emotional state, a prompt sentence to the generative AI model and generate feedback information including technical advice information and advice information corresponding to a psychological state of the user, transmit the feedback information to a terminal device including the image acquisition unit via the communication unit and present the feedback information in real time by using a display device or an audio output device, and record the analysis result data and the emotional state for each user and for each session and evaluate a progress of the user based on time-series transitions of motion performance and emotional state. This enables tight integration of time-series motion analysis, emotion estimation, and generative feedback generation within a single processing architecture, reduces redundant computation and I/O operations, improves latency and throughput for real-time feedback on general-purpose computing hardware, and allows the server to adaptively generate high-relevance feedback while maintaining structured progress records that can be used for efficient resource management and accurate usage-based or subscription-based billing.

The term “system” refers to an information processing apparatus or a set of interconnected information processing apparatuses including at least one processor and associated hardware and software components configured to execute the functions described herein.

The term “processor” refers to one or more hardware processing circuits, such as a central processing unit, a graphics processing unit, or a dedicated logic circuit, configured to execute instructions and thereby implement the functions of the present invention.

The term “image acquisition unit” refers to a hardware device or combination of hardware and software configured to capture digital image data, such as moving image data or still image data, representing a user's physical motion or work motion.

The term “communication unit” refers to a hardware interface and associated communication software configured to transmit and receive data, including image data and feedback information, between the system and an external device over a communication network. The term “moving image data” refers to time-series digital image data representing a sequence of frames that depict motion of a target object, such as a user or a workpiece, over time.

The term “still image data” refers to digital image data representing a single frame or a limited number of frames that capture a static or quasi-static state of a target object. The term “target object” refers to an entity appearing in the moving image data or the still image data, including at least a part of a user's body, an implement handled by the user, or an industrial mechanism whose motion is to be analyzed.

The term “image processing unit” refers to software and, where applicable, dedicated hardware configured to perform computation on image data, including operations such as frame decoding, resizing, filtering, feature extraction, and region detection.

The term “feature point information” refers to data representing positions or attributes of characteristic points associated with a target object, such as joint locations, key landmarks, or tracking points detected in the image data.

The term “posture change information” refers to time-series data representing variation of positions, orientations, or angles of parts of the target object over time, derived from the feature point information.

The term “motion feature data” refers to structured data derived from the posture change information and configured to numerically or symbolically represent motion efficiency, angles, posture deviation, or other kinematic characteristics of the target object.

The term “motion efficiency” refers to an index or set of indices indicating how effectively a motion achieves an intended task, including measures such as movement smoothness, task completion time, and amount of unnecessary motion.

The term “angle” refers to a quantitative value representing a geometric relationship between parts of a target object, such as a joint angle between body segments or an incidence angle of an implement relative to a reference direction.

The term “posture deviation” refers to a difference between an observed posture of a target object and a reference posture, expressed as angular deviation, positional offset, or other quantitative metric.

The term “attribute information” refers to metadata associated with the moving image data or the still image data, including at least one of scenario type, user identifier, device type, time information, or environmental conditions.

The term “generative AI model” refers to a trained computation model, implemented by machine learning algorithms, configured to generate output data such as natural-language text or structured recommendations based on input data and a prompt sentence.

The term “generative information processing model” refers to a generative AI model or an equivalent computation model that generates information by learning statistical relationships from training data rather than using fixed rule-based logic.

The term “prompt sentence” refers to an input text or structured textual instruction provided to a generative information processing model, the text specifying an analysis purpose, desired output format, or constraints for the generated output.

The term “analysis result data” refers to structured data produced by the generative information processing model, the data including at least an evaluation result of the motion feature data and optionally additional derived indicators.

The term “face region” refers to a portion of image data corresponding to a user's face, extracted or localized by an image processing operation such as face detection. The term “audio signal” refers to digital data representing sound associated with a motion or work scene, including at least voice produced by the user and optionally environmental sounds.

The term “emotional state” refers to a classification or estimation of a user's psychological condition, such as frustration, joy, fatigue, calmness, or stress level, derived from analysis of at least the face region and the audio signal.

The term “feedback information” refers to information generated for presentation to the user, the information including at least technical advice information and advice information corresponding to the user's psychological state.

The term “technical advice information” refers to part of the feedback information that provides concrete suggestions for modifying motion characteristics, such as angles, timing, or trajectories, to improve performance, efficiency, or safety.

The term “advice information corresponding to a psychological state” refers to part of the feedback information that provides suggestions or guidance tailored to the user's emotional state, such as relaxation methods, motivational messages, or pacing recommendations.

The term “terminal device” refers to a user-operated computing device including at least the image acquisition unit and a user interface, such as a portable information terminal, a wearable device, or an industrial control terminal.

The term “display device” refers to a visual output apparatus, such as a screen, panel, or head-mounted display, configured to present graphical or textual information to the user. The term “audio output device” refers to a sound reproduction apparatus, such as a speaker or headphone, configured to output audio corresponding to feedback information.

The term “presentation in real time” refers to output of feedback information to the user with a latency sufficiently short that the feedback can be used during or immediately after performance of the relevant motion, as determined by system design requirements. The term “session” refers to a unit of processing associated with acquisition, analysis, and feedback for one continuous or logically grouped set of user motions or work tasks. The term “time-series transitions of motion performance” refers to variation of motion feature data or derived performance indices across multiple sessions or within a session, evaluated along a time axis.

The term “time-series transitions of emotional state” refers to variation of emotional state estimates across multiple sessions or within a session, evaluated along a time axis.

The term “progress of the user” refers to an assessment of improvement or change in a user's motion performance and emotional state over time, derived from the recorded analysis result data and emotional state.

The term “usage fee” refers to an amount of monetary charge determined based on use of at least the feedback information acquisition or progress evaluation functions of the system. The term “per-use charging processing” refers to processing that calculates and executes payment for individual uses or events, such as a single feedback generation or evaluation, typically through interaction with an external payment device.

The term “use contract information” refers to data representing an agreement between a user and a service provider, including at least a usage period, a fee plan, and permitted functions of the system.

The term “periodic use period” refers to a predefined duration of service availability, such as a week, month, or year, associated with a subscription or similar contract.

The term “fee plan” refers to a structure defining how charges are assessed for system usage, including at least a base rate, usage limits, or tiered pricing conditions.

The term “periodic charging processing” refers to processing that calculates and executes payment at regular intervals based on the use contract information, typically through an external payment device.

The term “external payment device” refers to a system or service external to the claimed system that performs payment authorization, fund transfer, or settlement operations based on payment information provided by the processor.

In the following embodiments, a “server” denotes an information processing apparatus including at least one processor, main memory, non-volatile storage, and communication interfaces. A “terminal” denotes a user-operated device such as a portable information terminal or a wearable device including an imaging device, a display device and/or an audio output device, local storage, and a communication interface. A “user” denotes a person performing a physical motion or work motion and operating the terminal.

### A. Overall System Configuration

Server executes an operating system (for example, a general-purpose server operating system) and application software implementing modules such as an image processing unit, a motion feature extraction unit, a generative AI model execution unit, an emotion estimation unit, a feedback generation unit, a progress evaluation unit, and a billing management unit. Server uses one or more hardware processing circuits such as a central processing unit and, in some embodiments, a graphics processing unit or a dedicated accelerator to execute intensive numerical computation.

Terminal executes a client application that controls an imaging device such as a high-resolution camera, local storage, a network interface, and a user interface. Terminal may be implemented as a smartphone, a tablet-type terminal, or a head-mounted display device. Terminal includes an audio output device such as a speaker or headphones and, optionally, a microphone to acquire audio signals.

User attaches or holds the terminal so that the imaging device can capture the user's body region or a work area. User performs a motion such as a sports motion, a work motion, or a manipulation of an industrial mechanism while the terminal records image data.

### B. Hardware and Software Components

Server uses software libraries and frameworks to implement specific functions. For image analysis, server uses a computer vision library such as a general-purpose open-source image processing library, which provides functions for frame decoding, resizing, filtering, edge detection, and feature point detection. For machine learning, server uses a numerical computation framework such as a tensor computation framework or another deep learning framework, which provide automatic differentiation and optimized kernels for linear algebra operations.

Server implements a generative AI model within the machine learning framework. In one embodiment, server uses a sequence-to-sequence neural network architecture that includes a feature encoder and a text decoder. The feature encoder includes convolutional neural network layers applied to per-frame posture feature maps, followed by recurrent layers such as gated recurrent units or long short-term memory cells along the time axis to summarize motion dynamics. The text decoder includes a transformer-based language generation module that receives a prompt sentence and an embedding of the motion feature summary and outputs a sequence of tokens representing feedback text.

Server implements an emotion estimation unit as a combination of a facial expression classifier and an audio-based emotion classifier. The facial expression classifier may be a convolutional neural network trained on labeled facial expression data, taking as input aligned face regions and outputting probabilities for discrete emotions such as joy, frustration, fatigue, and calmness. The audio-based classifier uses acoustic features such as mel-frequency cepstral coefficients, pitch contour, and energy to estimate emotion probabilities through a recurrent neural network.

Terminal uses an application framework provided by its operating system to control the imaging device, local file system, network stack, and graphical user interface. Terminal application formats captured data into a specific data structure that includes an image stream, optionally an audio track, and metadata such as user identifier, context label, and device orientation.

### C. Data Structures and Internal Representations

Server stores incoming image data as a sequence of frames in a compressed video file format on non-volatile storage. Server further maintains an internal data structure, for example a three-dimensional tensor of shape [T, H, W, C], where T denotes the number of frames, H and W denote height and width of each frame after resizing, and C denotes color channels. Server converts detected feature points into a time-series structure. For each frame, server stores K keypoints representing joints or reference points as a matrix of shape [K, 2] or [K, 3] for two-dimensional or three-dimensional coordinates. Server aggregates these frame-wise matrices into a tensor of shape [T, K, D], where D denotes the dimensionality of the coordinate representation. Server further stores derived angle values as an array, where each entry corresponds to an angle between two segments associated with three keypoints. Server stores emotion estimation results as time-stamped records, for example as a list of tuples (time, emotion_label, probability_vector). Server associates each emotion record with a session identifier and a user identifier. For progress evaluation, server maintains a historical database of per-session statistics, including distributions of motion efficiency indices, angle deviations relative to reference values, safety risk flags, and emotion trends.

### D. Motion Feature Extraction and Technical Effect

Server uses the image processing unit to decode and normalize frames. Server executes spatial filtering to reduce noise and to enhance edges. Server applies a pose estimation algorithm that is not merely a template match but a learned mapping from image features to joint coordinates. In one embodiment, server uses a deep network with a backbone convolutional feature extractor followed by deconvolutional layers that output heatmaps representing likelihoods of joint positions. Server then uses a differentiable arg-max or soft-arg-max operation to convert heatmaps into continuous keypoint coordinates. By encoding joint locations into a compact tensor representation and computing joint angles and velocities through vector arithmetic and finite differencing, server avoids repeatedly processing original high-resolution frames for each subsequent analysis. This reduces memory bandwidth usage and enables server to cache intermediate feature representations. As a result, server improves overall processing speed and reduces communication load between CPU and GPU compared to a naive architecture that repeatedly reads and processes raw image frames.

Server computes motion efficiency indices by defining deterministic functions of the time-series features. For example, server computes total path length of an end-effector, number of direction reversals, and average speed, and normalizes these by task duration. Server defines posture deviation as the root-mean-square difference between observed joint angles and a reference profile stored in a template database. These explicit quantitative definitions reduce ambiguity and enable reliable comparison across sessions, which in turn improves the stability and precision of evaluations relative to purely qualitative assessments.

### E. Generative AI Model and Prompt Sentence Construction

Server does not simply send raw measurements to the generative AI model. Instead, server constructs a structured prompt sentence that encodes the analysis context, quantitative data, and desired output format. Server performs a deterministic algorithm to synthesize the prompt from motion feature data and emotion state.

Server converts numeric motion metrics into textual phrases according to predefined thresholds and formatting rules. For example, when an incidence angle deviates by more than a first threshold, server generates a phrase such as “the incidence angle is 5 degrees too steep,” whereas deviations within a second, smaller threshold may be described as “slightly too steep.” Server similarly converts temporal metrics into phrases such as “the hand speed is 10% slower than target” or “the task completion time is 15% longer than average.”

Server embeds the estimated emotional state in the prompt using controlled vocabulary, for example “the user shows signs of frustration” or “the user appears calm and focused.” Server appends constraints on the feedback, such as the required number of suggestions or the requirement to include relaxation advice.

In one example, server constructs a prompt sentence as follows: “Analyze the following motion analysis results and emotion state. The user's swing incidence angle is 5 degrees too steep, the wrist angle at the top is 10 degrees too large, and the user shows signs of frustration. As a generative AI model, please provide three concrete improvement methods, including specific angle adjustments and simple practice drills, and add one short relaxation tip suitable for a frustrated user.”

In another example concerning work safety, server constructs:

“Analyze the factory worker's lifting motion: the back is bent forward by 20 degrees, knee flexion is insufficient, and the task completion time is 15% longer than average. The worker shows signs of fatigue. As a generative AI model, propose safe posture corrections, ways to increase efficiency, and advice on when to take breaks.”

By algorithmically constructing the prompt sentence from structured numerical features and emotion estimates, server ensures that the generative AI model receives a rich, machine-curated context that cannot be easily reproduced by manual ad-hoc text. This non-conventional pre-processing leads to more consistent, relevant, and technically grounded feedback, thereby improving the overall performance of the computer system when executing feedback generation workloads.

### F. Internal Training and Execution of the Generative AI Model

Server trains the generative AI model offline using supervised learning. Server constructs a training dataset composed of pairs of (input, target_output), where each input includes encoded motion feature tensors, emotion labels, and a corresponding prompt sentence, and each target_output is an expert-written feedback text. Server defines a loss function such as a token-level cross-entropy between model-generated sequences and reference feedback sequences. Server uses mini-batch gradient descent, with backpropagation through time for the recurrent or transformer layers, to update network parameters.

Server applies data augmentation techniques to improve generalization. For motion features, server synthetically perturbs angles within a limited range, simulates measurement noise, or warps time axes slightly. For prompts, server introduces controlled paraphrasing while preserving semantic content. By training under such variation, the model learns robust mappings between quantitative motion patterns, emotion states, and high-quality feedback text.

At inference time, server receives the prompt sentence and a condensed embedding of the motion feature data as inputs to the text decoder. Server uses beam search or constrained decoding strategies to generate output tokens. Server may limit maximum sequence length and forbid undesired token sequences according to rules, thereby ensuring that generated feedback remains concise and technically pertinent.

This detailed integration of structured motion features, emotion states, and controlled prompting into a single generative architecture improves both accuracy and computation efficiency compared to naive text-only generative systems. The server's architecture thus constitutes a specific improvement in computer technology for motion-analysis-based feedback generation.

### G. Emotion Estimation and its Integration

Server implements the emotion estimation unit such that it operates on the same time-axis alignment as the motion feature data. Server extracts face regions in a subset of frames sampled at regular intervals, standardizes their size, and normalizes pixel intensities. Server passes these standardized images through a trained convolutional classifier that outputs emotion probability distributions. Server assigns an emotion label by selecting the maximum probability category, and aggregates labels over time using smoothing filters such as exponential moving averages.

Server processes audio by computing spectrograms or mel-frequency coefficient sequences from the audio signal. Server passes these features through a recurrent classifier to obtain temporal emotion probabilities. Server combines visual and audio emotion evidence using a fusion rule, such as a weighted average or a small multilayer perceptron that takes as input both visual and audio probability vectors.

By aligning emotion estimates with motion events and by storing both in a shared session record, server can detect correlations such as increased frustration when certain posture deviations occur. Server uses these correlations to adjust progress evaluation and to prioritize specific types of advice. This coupling of emotion and motion data structures is not a mere human-like interpretation, but a concrete way to steer subsequent computational processing so that resources are focused on problematic motion segments.

### H. Feedback Generation and Presentation

Server uses the feedback generation unit to combine outputs from the generative AI model with deterministic checks. For example, when a safety-related threshold is exceeded, server ensures that the feedback includes at least one safety-oriented recommendation, regardless of the generative output. Server may prepend mandatory warnings to the generated text or adjust phrasing to emphasize safety.

Terminal receives the feedback information and renders it through the display device and/or the audio output device. Terminal can present numeric values alongside textual explanations, such as “Back bending: 20 degrees (exceeds safe threshold of 10 degrees)” or “Wrist angle deviation: 10 degrees.” Terminal may highlight specific frames from the recorded image data and overlay graphical elements such as lines or arrows representing ideal postures.

By tightly coupling feedback content with precisely located motion features, the system enables the user to visually verify and understand the advice, which in turn facilitates faster learning. From a technical standpoint, this reduces the number of repeated sessions needed to reach a target quality of motion, thereby decreasing overall computational workload per user goal.

### I. Progress Evaluation and Billing

Server stores, for each session, summarized metrics such as mean and variance of angle deviations, normalized motion efficiency scores, counts of safety warnings, and distributions of emotion states. Server uses algorithms such as moving averages and trend detection to evaluate progress. For example, server may determine that the user's mean incidence angle error has decreased from 8 degrees to 3 degrees over several sessions while the fraction of frames labeled as high stress has also decreased.

Server determines whether to adjust analysis parameters, such as tightening thresholds for advanced users or altering content of prompts to focus on finer details. This adaptive adjustment of analysis and prompting, based on stored time-series data, provides an improvement to the underlying computing process by avoiding redundant or unnecessary processing for already mastered aspects.

Server also uses these structured records for billing control. For per-use charging, server increments usage counters only when feedback generation is successfully completed, using the exact number of feedback events rather than coarse session counts. For subscription-based charging, server cross-checks active usage against contracted limits. This tight coupling between internal processing outcomes and billing logic reduces inconsistencies and allows efficient scaling of computing resources.

### J. Alternative Embodiments and Variations

Server may be implemented on different hardware configurations. In one embodiment, server runs on a single physical machine with a multi-core processor and an attached processor for acceleration. In another embodiment, server distributes the image processing unit and generative AI model execution across multiple nodes in a cluster, communicating via an internal network. The same architectural principles of feature extraction, prompt construction, and generative feedback remain.

Terminal may be a handheld device, a head-mounted device, or a stationary camera system. In an industrial environment, terminal may be mounted on a machine frame to observe a worker or a robot. The system can be configured so that terminal streams frames directly to server with minimal buffering when near real-time response is prioritized.

Server may employ different neural architectures depending on application requirements. For example, a lighter-weight recurrent model may be used for low-latency scenarios, while a transformer-based architecture may be used for more complex motion patterns. In each case, server continues to generate prompt sentences from structured motion features and emotion states and to use those prompts to drive generative feedback.

In still another embodiment, server supports multiple languages by using language-specific decoder heads sharing a common encoder. Prompt sentences are generated in the target language, and the decoder is trained with feedback data in that language. This allows the same underlying motion feature representation to be reused across languages, which is a technical efficiency in model design and training.

### K. Technical Effect and Improvement of Computer Technology

By integrating time-series motion feature extraction, emotion estimation, and prompt-driven generative feedback within a cohesive architecture, the system improves the operation of the server beyond a generic data processing engine. The use of compact feature tensors and time-aligned emotion records reduces the need to reprocess raw image data, thereby improving processing speed and reducing memory and communication overhead. The deterministic construction of prompt sentences from structured, quantitative data provides the generative AI model with a richer, machine-optimized context than ad-hoc human prompts, increasing accuracy and stability of outputs.

Further, the combination of numerical thresholds, explicit angle and efficiency computations, and learned generative text outputs implements a hybrid rule-based and data-driven control loop that is not a mere automation of human judgment. Instead, server executes algorithmic operations on data structures that humans cannot manipulate at the same speed or dimensionality, such as multi-hundred-dimensional feature tensors and large-scale neural network parameter vectors. As a result, the system achieves reduced latency for real-time feedback, improved precision in motion and emotion assessment, and more efficient use of computing and network resources.

Because these improvements arise from specific data structures, algorithms, and architectures implemented inside the server and terminal, and because the system is applied to control or guide physical motion in the real world, the invention is not limited to an abstract idea. Rather, it constitutes a concrete improvement in computer technology for integrated motion analysis and generative feedback systems.

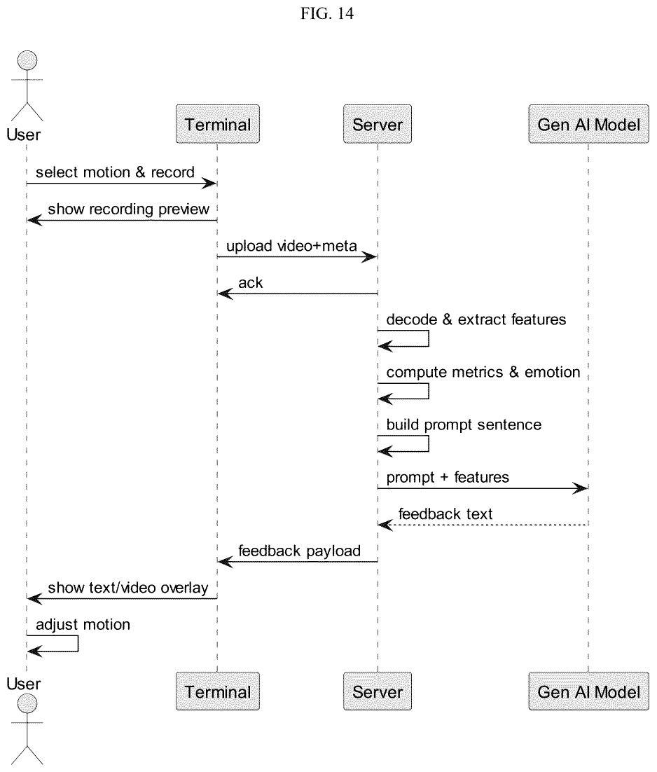

The following describes the processing flow using FIG. 14.

### Step 1

User prepares motion scene for recording.

User positions the terminal so that the camera can capture the relevant body region or work area and selects a motion type (for example, sports motion or work motion) in a terminal application. Input is the user's intent and selected motion type; output is a recording configuration specifying camera orientation, frame rate, resolution, and scenario label. User adjusts the environment (for example, lighting and distance) according to on-screen guidance so that the captured images satisfy minimum quality thresholds.

### Step 2

Terminal captures image and audio data.

Terminal activates the imaging device and, optionally, a microphone, then starts recording when the user taps a record button. Input is the recording configuration and sensor signals from the camera and microphone; output is raw moving image data and, optionally, an audio signal stored in local storage as a file (for example, a compressed video container). Terminal timestamps frames, associates them with the selected motion type, and writes metadata such as device orientation and approximate distance to the user.

### Step 3

Terminal uploads recorded data to server.

Terminal reads the stored file, compresses and, if necessary, re-encodes the moving image data and audio data to a target bitrate, and establishes a secure communication session with server. Input is the recorded file and metadata; output is a data packet stream transmitted over a network to server. Terminal fragments the file into transmission units, attaches headers including user ID, session ID, and scenario label, and sends the packets over a communication protocol such as HTTPS.

### Step 4

Server receives and stores session data.

Server listens on a network interface for incoming requests and accepts the connection from terminal. Input is the packet stream containing compressed video, audio, and metadata; output is a reconstructed session file stored on non-volatile storage and a session record created in a database. Server validates checksums, reassembles packets, verifies file format, and registers the session by writing entries containing user ID, timestamps, and file path.

### Step 5

Server decodes and normalizes image frames.

Server reads the session file from storage and uses an image processing library to decode the compressed video into individual frames. Input is the stored session file; output is a normalized frame tensor with dimensions [T, H, W, C]. Server resizes each frame to a target resolution, converts color space, applies noise reduction (for example, Gaussian filtering), and scales pixel values to a predefined range, thereby preparing data suitable for subsequent feature extraction.

### Step 6

Server extracts pose keypoints and constructs motion features.

Server applies a pose estimation algorithm to each normalized frame to detect coordinate positions of predetermined keypoints such as joints and reference points. Input is the frame tensor; output is a time-series tensor of keypoint coordinates with shape [T, K, D] and derived angle arrays. Server computes joint angles by vector arithmetic between keypoints and calculates time-derivative quantities such as angular velocity and path length. Server aggregates these computations into motion feature data representing motion efficiency, angles, and posture deviation.

### Step 7

Server computes motion efficiency and posture deviation metrics.

Server compares the motion feature data to reference templates stored in a database. Input is the time-series motion feature data and reference profiles; output is a set of scalar and vector metrics such as incidence angle deviation, posture deviation scores, efficiency indices, and safety risk flags. Server performs numerical operations including root-mean-square error calculations, threshold comparisons, and normalization by task duration to derive these metrics.

### Step 8

Server estimates user emotion from visual and audio cues.

Server extracts face regions from selected frames and spectral features from the audio signal. Input is the normalized frames and audio track; output is an emotional state estimate with associated probabilities over emotion classes. Server feeds face regions into a trained facial expression classifier and audio features into a trained acoustic emotion classifier, then combines the resulting probability vectors using a fusion algorithm to determine a dominant emotion and its confidence. Server writes these emotion records to the session record.

### Step 9

Server converts numeric results into textual descriptions.

Server transforms quantitative motion and emotion metrics into standardized textual phrases. Input is the set of metrics and emotion probabilities; output is a structured set of text fragments describing deviations, efficiencies, and emotional state. Server applies predetermined rules to map numeric ranges to phrases such as “5 degrees too steep” or “15% slower than average,” and selects emotion descriptors such as “shows signs of frustration” based on probability thresholds.

### Step 10

Server constructs a prompt sentence for the generative AI model.

Server assembles a prompt sentence by concatenating scenario information, textual descriptions of motion metrics, the emotional state, and generation constraints. Input is the structured text fragments and scenario metadata; output is a single prompt sentence encoded as a character or token sequence. Server inserts directives specifying the desired number of improvement suggestions and the requirement to include emotion-aware advice. For example, server may construct the prompt sentence:

“Analyze the following motion analysis results and emotion state. The user's swing incidence angle is 5 degrees too steep, the wrist angle at the top is 10 degrees too large, and the user shows signs of frustration. As a generative AI model, please provide three concrete improvement methods, including specific angle adjustments and simple practice drills, and add one short relaxation tip suitable for a frustrated user.”

### Step 11

Server generates feedback text using a generative AI model.

Server feeds the prompt sentence and, in some implementations, an embedding of the motion feature data into a trained generative AI model. Input is the prompt sentence and feature embedding; output is a sequence of tokens forming feedback text. Server runs inference on a neural network that decodes tokens using beam search or another decoding strategy, then converts the tokens to plain text. Server optionally post-processes the text by enforcing length limits, removing duplication, and segmenting content into sections such as technical advice and psychological advice.

### Step 12

Server assembles feedback information payload.

Server combines the generated feedback text with key numerical highlights and references to specific frames. Input is the generated text, motion metrics, and frame indices; output is a structured feedback payload ready for transmission to terminal. Server may attach frame identifiers where certain posture deviations are maximal and include numeric fields for angles and efficiency scores alongside the narrative text.

### Step 13

Server transmits feedback to terminal.

Server encodes the feedback payload and sends it to terminal over the existing or a new secure connection. Input is the feedback payload; output is a network response message or push notification arriving at terminal. Server sets response headers including session ID and timestamps so that terminal can correctly match the feedback with the original recording.

### Step 14

Terminal receives and parses feedback.

Terminal listens for incoming feedback messages and, upon reception, decodes the payload. Input is the received response message; output is an internal representation containing feedback text, numeric values, and frame references. Terminal verifies the session ID, stores the feedback in local storage, and updates the application state to indicate that new feedback is available for the user.

### Step 15

Terminal presents feedback to user.

Terminal renders the feedback text on the display device and optionally generates an audio narration. Input is the internal feedback representation; output is visual and/or auditory content perceived by the user. Terminal displays sections such as “Angles and Posture,” “Efficiency and Safety,” and “Emotion-based Advice,” highlights key numbers, and overlays graphical annotations on selected video frames. Terminal may convert feedback text to speech and play it through the audio output device while synchronizing visual highlights with the spoken instructions.

### Step 16

User reviews feedback and adjusts subsequent motion.

User reads or listens to the presented feedback and determines specific changes to implement in the next attempt. Input is the displayed or spoken feedback; output is a modified motion strategy executed by the user. User may adjust joint angles, timing, or movement paths according to the technical advice, and may follow relaxation or pacing recommendations based on the psychological advice.

### Step 17

Server updates progress records and, if applicable, billing data.

Server updates the user's historical record with the latest motion metrics, emotional state, and feedback summary. Input is the session analysis data and a record of feedback generation; output is an updated progress log and, where enabled, updated usage counters. Server computes trend indicators such as improvements in average angle error or reductions in stress markers and stores them for later retrieval. If billing is active, server increments per-use counters or checks subscription validity and records charging events associated with this session.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

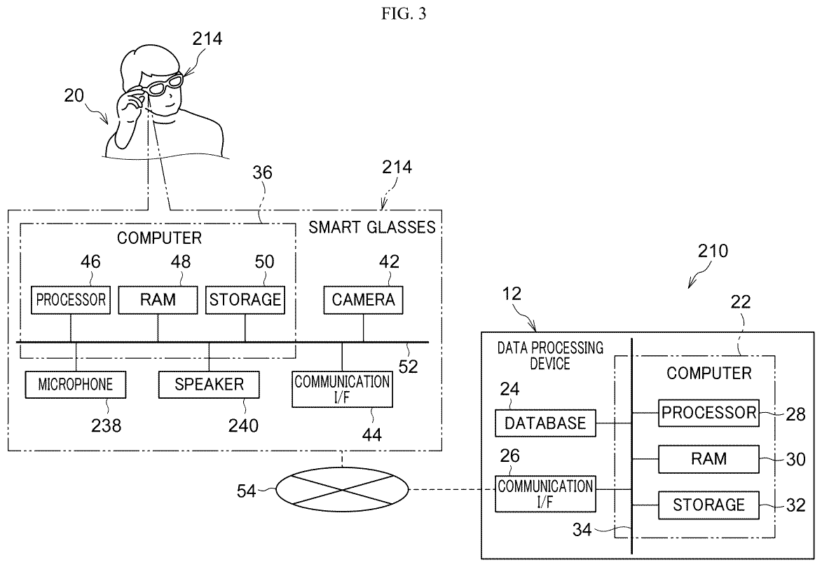

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

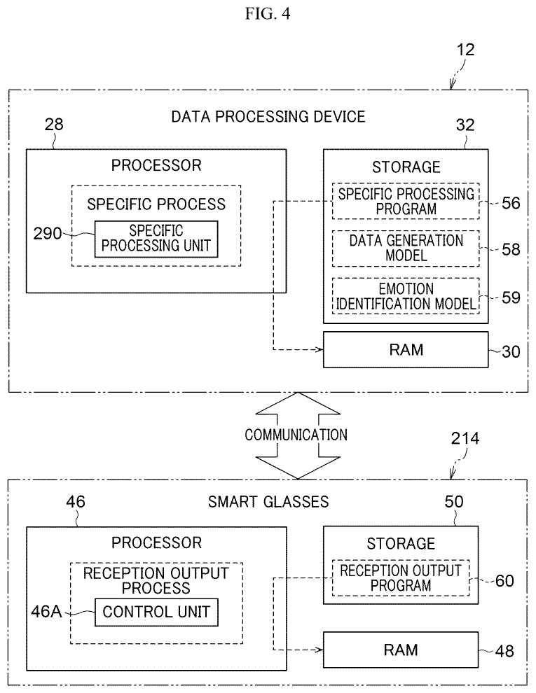

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

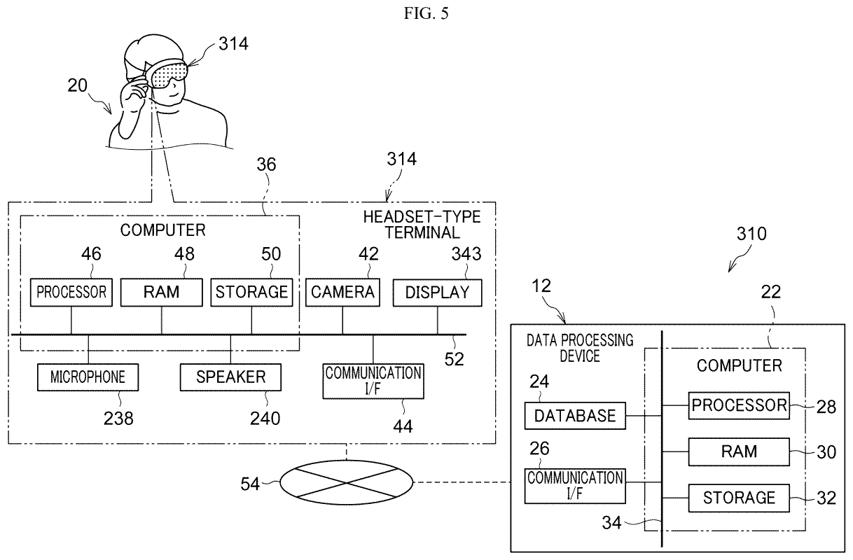

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

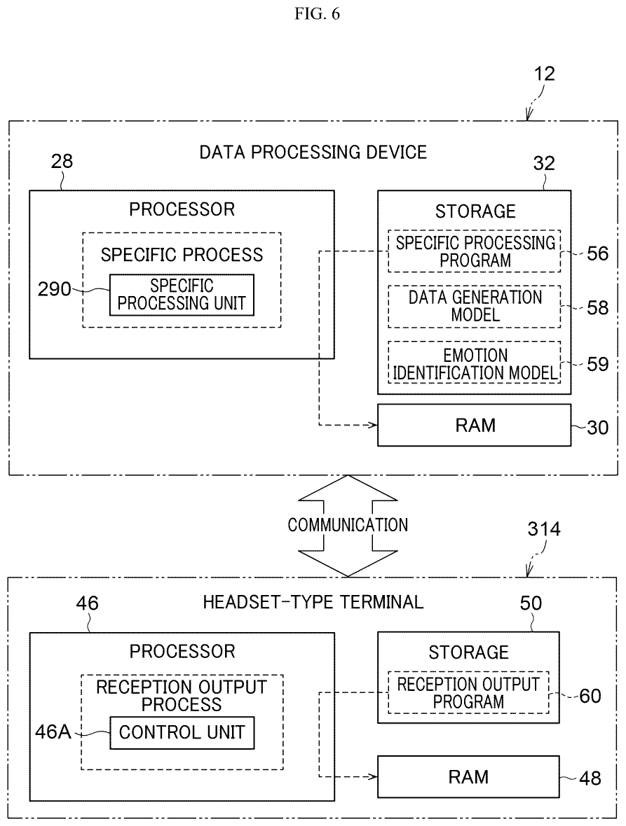

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

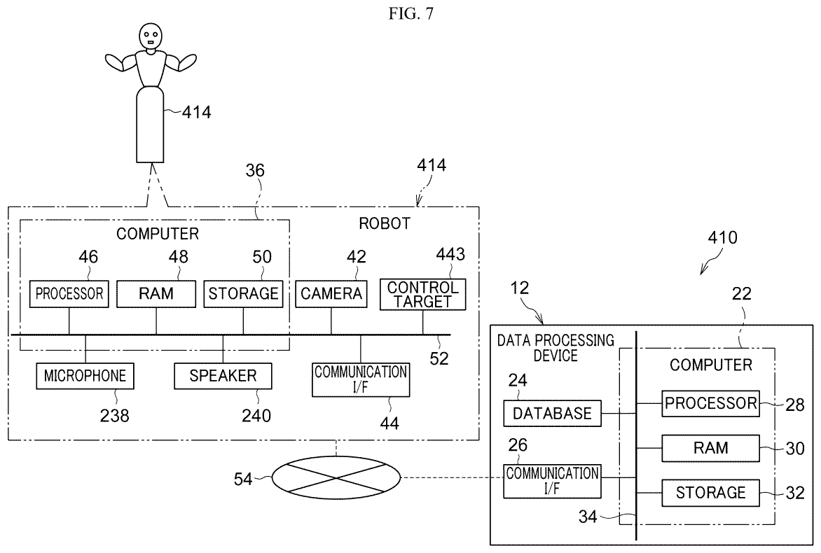

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

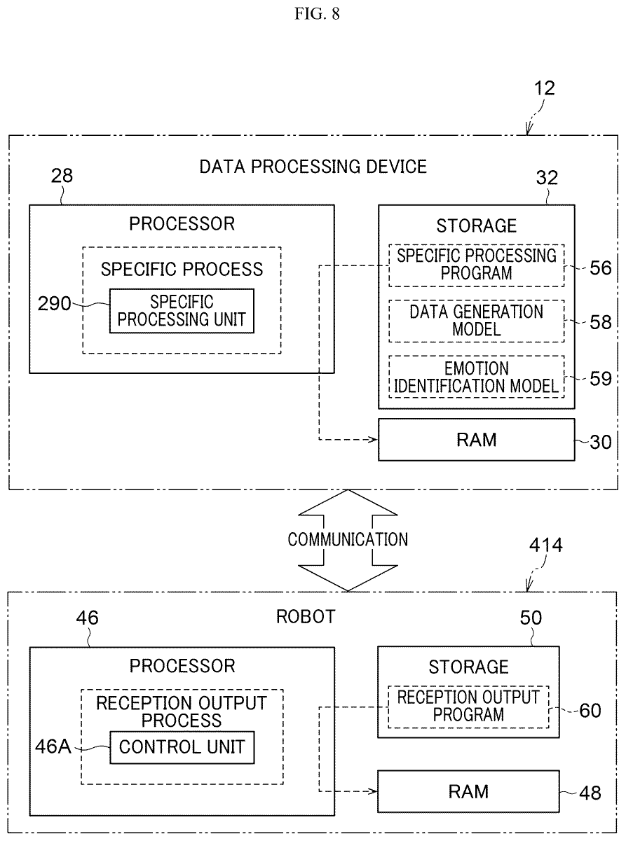

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

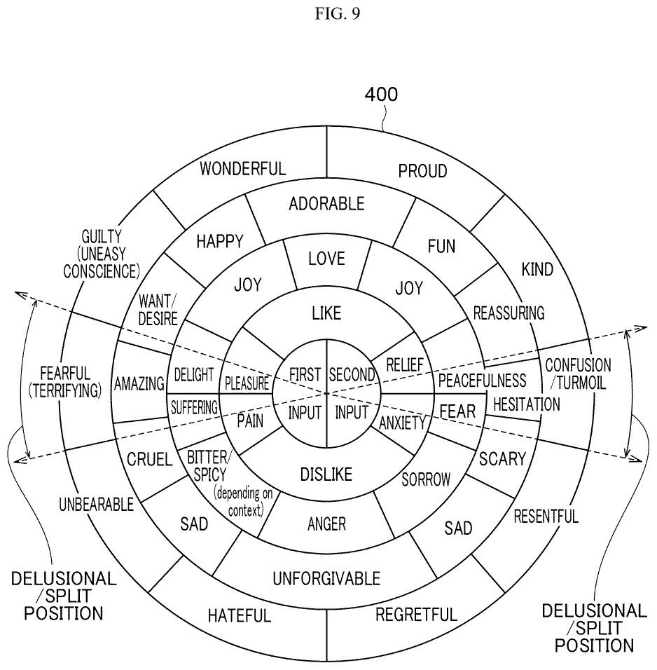

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

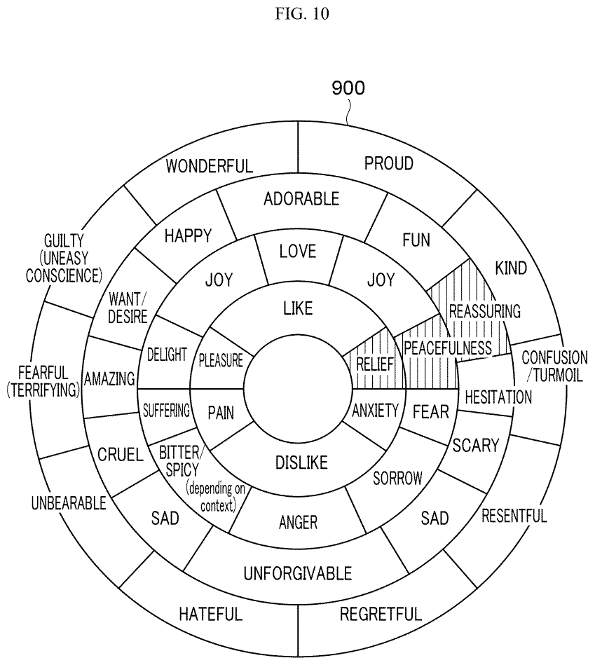

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
control an input/output device and a storage device of a portable information terminal so that a user records a motion scene including a body movement of the user as motion image data by using the portable information terminal and stores the motion image data in the storage device,
control a communication device and a communication protocol of the portable information terminal so that the portable information terminal transmits the motion image data and user identification information to a server via a communication network,
receive, on a server side, the motion image data from the portable information terminal, verify data integrity of the motion image data, store the motion image data in an external storage device, and manage the motion image data in association with the user identification information and processing state information,
acquire, on the server side, the motion image data from the external storage device, decompose the motion image data into a frame sequence by using an image processing program, normalize the frame sequence to a predetermined number of pixels and a predetermined frame rate, and convert the normalized frame sequence into feature data expressed as numerical arrays as preprocessing,
generate, on the server side, a prompt sentence based on the feature data and condition information including a motion type to be analyzed, a user attribute, and an output format, the prompt sentence defining an analysis objective and an output format for a generative AI model,
execute, on the server side, the generative AI model constructed by a machine learning framework using the prompt sentence and the feature data as inputs, calculate positions of body parts, joint angles, motion speeds, and motion patterns in the motion scene, generate analysis result data including at least motion efficiency, posture deviation, and timing deviation based on a comparison between the motion patterns and reference motion patterns, and generate feedback text expressed in a natural language in accordance with the analysis result data,
input, on the server side, the analysis result data into a recognition processing program together with expression data and voice data representing information on an emotion of the user, determine an emotional state of the user, and adjust content, expression level, and presentation order of the feedback text according to the emotional state as feedback adjustment, and
generate, on the server side, adjusted feedback text and analysis indices as structured data, transmit the structured data to the portable information terminal via the communication network, and cause the portable information terminal to analyze the structured data by a user interface program and to present the structured data as a screen display or an audio output so that the user is enabled to confirm the feedback and iteratively record and improve the motion scene.

### Supplementary 2

The system according to supplementary 1,
wherein the processor is configured to
identify a usage unit for each execution of the analysis and the feedback adjustment, calculate a usage fee corresponding to the usage unit, perform payment processing for a per-use fee of the user in cooperation with a payment service, and control availability of the feedback presentation based on a result of the payment processing.

### Supplementary 3

The system according to supplementary 1,
wherein the processor is configured to
store registration information relating to a continuous usage contract for each user in the storage device, manage a number of executions or a period of execution of the analysis and the feedback adjustment based on the registration information, and provide the feedback presentation without requesting additional payment processing to a user satisfying a predetermined contract condition.

### Application Example 1

### Supplementary 1

A system comprising a processor, a storage device, a communication interface, and a user terminal including at least one of a portable terminal device and a wearable display device, wherein the processor is configured to
control an image capture function of the user terminal so that a user records own physical motion or work motion as moving image data, store the moving image data temporarily in the user terminal, and cause the moving image data to be transmitted from the user terminal to the system via a communication network,
store the received moving image data in the storage device, execute an image processing program to extract a plurality of still images from the moving image data, convert the still images to a predetermined resolution and format, and generate motion analysis data as preprocessed data,
execute at least one of a posture estimation model and a motion recognition model using the motion analysis data, calculate feature information representing a plurality of joint positions of a human body, joint angle information, and time-series change information, and generate motion evaluation information including at least one of a work efficiency index and a safety index,
generate a prompt sentence that includes the motion evaluation information as input information, input the prompt sentence into a generative AI model, and cause the generative AI model to generate natural-language text including an explanatory text and an improvement proposal text, and generate feedback information for presentation to the user based on the explanatory text and the improvement proposal text,
generate presentation data including time-series information indicating a correspondence between the feedback information and the moving image data, transmit the presentation data to the user terminal, and control display on the user terminal so that the feedback information is displayed in association with a playback position of the moving image data,
dynamically change contents of the prompt sentence input to the generative AI model in accordance with at least one of a posture risk level and an efficiency degradation level included in the motion evaluation information, and cause the generative AI model to generate a detailed improvement proposal text for a time interval in which at least one of the posture risk level and the efficiency degradation level is high, and
input the prompt sentence again to the generative AI model based on updated motion evaluation information obtained after generation of the feedback information, and cause the generative AI model to generate stepwise improvement proposal texts in multiple iterations so as to support iterative improvement of the user's motion.

### Supplementary 2

The system according to supplementary 1,
wherein the processor is configured to perform settlement processing for use of the system based on fee information corresponding to usage units for each user.

### Supplementary 3

The system according to supplementary 1,
wherein the processor is configured to store registration information and charging information relating to a periodic use contract for each user, and manage a usage right of the system based on the periodic use contract.

### Example 2

### Supplementary 1

A system comprising a processor,
wherein the processor is configured to control an information terminal having an imaging function and a network communication function so as to acquire image information including a user's physical motion or work motion and to cause the information terminal to transmit the image information to an information processing apparatus,
wherein the processor is configured to perform preprocessing on the image information transmitted to the information processing apparatus by using an image processing program to normalize pixel information, unify resolution, reduce noise components, and convert the image information into an input format for machine learning,
wherein the processor is configured to extract feature data indicating joint positions, postures, and arrangements of body portions of a subject from the preprocessed image information by using a machine learning program, and to calculate limb angles, trunk angles, posture inclinations, and motion trajectories on the basis of the feature data,
wherein the processor is configured to generate evaluation information indicating motion efficiency, angle deviation, and posture deviation by comparing the calculated angle information and posture information with reference motion information stored in a storage device,
wherein the processor is configured to automatically generate a prompt sentence including a motion target, a motion phase, measured values, and reference values on the basis of the evaluation information and the feature data, and to input the prompt sentence to a generative information processing model so as to cause the generative information processing model to generate analysis content and improvement proposals expressed in natural language, wherein the processor is configured to associate the analysis content and the improvement proposals output from the generative information processing model with the evaluation information to structure the associated information as feedback information, to generate display data including at least one of text information and graphic information from the feedback information, and to transmit the display data to the information terminal, and wherein the processor is configured to manage the feedback information and past feedback information so as to be stored and referenced in time series in response to operation information from the information terminal, and to generate information indicating an improvement state on the basis of changes in evaluation information at a plurality of time points.

### Supplementary 2

The system according to supplementary 1,
wherein the processor is configured to perform billing processing by receiving fee information and settlement information corresponding to a single use by a user and controlling usage rights of the system on the basis of the fee information.

### Supplementary 3

The system according to supplementary 1,
wherein the processor is configured to perform subscription management processing by managing registration information and contract information corresponding to continuous use by a user and controlling usage rights and service provision conditions of the system on the basis of the registration information and the contract information.

### Application Example 2

### Supplementary 1

A system comprising a processor,
wherein the processor is configured to
control an image acquisition unit configured to acquire a user's physical motion or work motion and a communication unit configured to transmit moving image data or still image data acquired by the image acquisition unit,
analyze, via an image processing unit, the moving image data or the still image data received via the communication unit to extract feature point information of a target object, and generate motion feature data indicating motion efficiency, angles, and posture deviation by generating posture change information along a time axis based on the feature point information,
input the motion feature data and attribute information associated with the moving image data or the still image data as input information, input a prompt sentence defining an analysis purpose and an output format to a generative AI model as a generative information processing model, and generate analysis result data including an evaluation result of the motion feature data by using the generative AI model,
extract a face region and an audio signal from the moving image data or the still image data, and estimate an emotional state of the user based on the face region and the audio signal, dynamically construct, based on the analysis result data and the emotional state, a prompt sentence to the generative AI model and generate feedback information including technical advice information and advice information corresponding to a psychological state of the user, transmit the feedback information to a terminal device including the image acquisition unit via the communication unit and present the feedback information in real time by using a display device or an audio output device, and
record the analysis result data and the emotional state for each user and for each session and evaluate a progress of the user based on time-series transitions of motion performance and emotional state.

### Supplementary 2

The system according to supplementary 1,
wherein the processor is configured to
calculate a usage fee based on at least one of a number of acquisitions of the feedback information and a number of evaluations by progress evaluation processing, and execute per-use charging processing via an external payment device.

### Supplementary 3

The system according to supplementary 1,
wherein the processor is configured to
store use contract information of the user, manage availability of generative information processing based on a periodic use period and a fee plan, and execute periodic charging processing via an external payment device.

What is claimed is:

1. A system comprising:
circuitry configured to:
receive, via a communication interface coupled to a packet-switched network, motion image data and user identification data transmitted from a terminal device;
verify data integrity of the received motion image data, store the motion image data in a storage device in association with the user identification data, decompose the motion image data into a frame sequence, normalize the frame sequence to a predetermined resolution and frame rate, and convert the normalized frame sequence into feature data expressed as numerical arrays;
generate, based on the feature data and condition data comprising a motion type parameter and an output format specification, a prompt sentence defining an analysis objective and an output format, and input the prompt sentence and the feature data to a generative neural network model;
receive from the generative neural network model analysis result data comprising joint angle data, motion efficiency data, posture deviation data, and feedback text expressed in natural language;
input the analysis result data together with expression data and voice data of a user from the terminal device to an emotion recognition model to determine an emotion state parameter, and adjust at least one of content, expression level, or presentation order of the feedback text based on the emotion state parameter; and
generate structured output data comprising the adjusted feedback text and analysis indices, and transmit the structured output data to the terminal device.

2. The system according to claim 1, wherein the circuitry is configured to
apply a convolutional neural network to frames of the frame sequence to extract spatial feature maps, apply a temporal model to a sequence of the spatial feature maps to generate motion pattern data, and compare the motion pattern data against reference motion pattern data stored in a memory to compute a deviation metric.

3. The system according to claim 2, wherein the circuitry is configured to
compute joint angles from keypoint coordinates extracted from the spatial feature maps, compute motion speeds from temporal differences between consecutive keypoint coordinate sets, and incorporate the computed joint angles, motion speeds, and deviation metric into the analysis result data.

4. The system according to claim 3, wherein the circuitry is configured to
generate the prompt sentence by selecting a prompt template based on the motion type parameter, substituting the feature data and the deviation metric into the prompt template, and appending the output format specification to the prompt template.

5. The system according to claim 4, wherein the circuitry is configured to
receive updated motion image data from the terminal device in response to the transmitted structured output data, process the updated motion image data through the frame decomposition, normalization, and feature extraction steps, and generate updated analysis result data to support an iterative motion improvement cycle.

6. The system according to claim 1, wherein the circuitry is configured to
apply a facial expression analysis model to expression data received from the terminal device to extract facial action unit data, apply a voice analysis model to voice data received from the terminal device to extract prosodic features, and combine the facial action unit data and the prosodic features to generate the emotion state parameter.

7. The system according to claim 6, wherein the circuitry is configured to
classify the emotion state parameter into one of a plurality of emotional state categories, select an adjustment strategy from a plurality of adjustment strategies based on the classified emotional state category, and apply the selected adjustment strategy to determine content, expression level, and presentation order of the feedback text.

8. The system according to claim 7, wherein the circuitry is configured to
detect a change in the emotion state parameter exceeding a state-change threshold between consecutive processing cycles, regenerate the prompt sentence to incorporate the updated emotion state parameter as an additional condition, and supply the regenerated prompt sentence to the generative neural network model to obtain updated feedback text.

9. The system according to claim 1, wherein the circuitry is configured to
store, in the storage device, a history of emotion state parameters, analysis result data, and adjusted feedback text associated with the user identification data, apply an adaptation algorithm to the stored history to adjust prompt template parameters, and generate subsequent prompt sentences using the adjusted prompt template parameters.

10. The system according to claim 9, wherein the circuitry is configured to
generate a personalization prompt sentence incorporating the stored history as context data, input the personalization prompt sentence to the generative neural network model, and receive personalized feedback text that reflects a trend in the motion patterns and emotion states stored in the history.

11. The system according to claim 1, wherein the circuitry is configured to
receive a request from the terminal device specifying a target motion type and a performance objective, generate a target-specification prompt sentence incorporating the target motion type and the performance objective, input the target-specification prompt sentence to the generative neural network model, and receive a specific improvement procedure from the generative neural network model for transmission to the terminal device.

12. The system according to claim 11, wherein the circuitry is configured to
compare the analysis result data against the performance objective to compute a progress metric, incorporate the progress metric into a subsequent prompt sentence, and receive updated feedback text reflecting the progress metric from the generative neural network model.

13. The system according to claim 1, wherein the circuitry is configured to
generate audio output data from the adjusted feedback text using a speech synthesis model, and transmit the audio output data to the terminal device for presentation as an audio output in parallel with a screen display of the structured output data.

14. The system according to claim 13, wherein the circuitry is configured to
adjust a speech rate and tone of the audio output data based on the emotion state parameter, wherein an elevated stress-level emotion state parameter causes the speech synthesis model to generate audio output data at a reduced speech rate with a calming tonal profile.

15. The system according to claim 1, wherein the circuitry is configured to
apply an anomaly detection algorithm to the analysis result data to detect motion patterns deviating from a safety threshold, generate a safety-alert message when a deviation exceeding the safety threshold is detected, and transmit the safety-alert message to the terminal device with higher transmission priority than the structured output data.

16. The system according to claim 1, wherein the circuitry is configured to
store, in the storage device, a plurality of reference motion pattern datasets associated with respective skill level identifiers, select a reference motion pattern dataset based on a skill level identifier received from the terminal device, and use the selected reference motion pattern dataset as a comparison baseline in the generative neural network model analysis.

17. The system according to claim 1, wherein the circuitry is configured to
generate a usage log entry recording a timestamp, the user identification data, the motion type parameter, and a processing state identifier for each processing cycle, store the usage log entry in the storage device, and compute usage statistics from stored usage log entries for transmission to a designated management terminal.

18. A system comprising:
circuitry configured to:
receive, via a communication interface coupled to a packet-switched network, motion image data from a terminal device, decompose the motion image data into a frame sequence, and convert the frame sequence into feature data expressed as numerical arrays after normalization;
generate a prompt sentence based on the feature data and a motion type parameter, input the prompt sentence and the feature data to a generative neural network model, and receive analysis result data comprising joint angle data, motion efficiency data, posture deviation data, and feedback text;
apply an emotion recognition model to expression data and voice data from the terminal device to generate an emotion state parameter, and adjust content, expression level, and presentation order of the feedback text based on the emotion state parameter; and
generate structured output data comprising the adjusted feedback text and analysis indices and transmit the structured output data to the terminal device.

19. The system according to claim 18, wherein the circuitry is configured to store a history of emotion state parameters and analysis result data in a storage device, apply an adaptation algorithm to the stored history to adjust prompt template parameters, and generate subsequent prompt sentences using the adjusted prompt template parameters to personalize feedback content.

20. A method performed by circuitry, the method comprising:
receiving, via a communication interface coupled to a packet-switched network, motion image data and user identification data transmitted from a terminal device;
verifying data integrity of the received motion image data, storing the motion image data in a storage device in association with the user identification data, decomposing the motion image data into a frame sequence, normalizing the frame sequence to a predetermined resolution and frame rate, and converting the normalized frame sequence into feature data expressed as numerical arrays;
generating, based on the feature data and condition data comprising a motion type parameter and an output format specification, a prompt sentence defining an analysis objective and an output format, and inputting the prompt sentence and the feature data to a generative neural network model;
receiving from the generative neural network model analysis result data comprising joint angle data, motion efficiency data, posture deviation data, and feedback text expressed in natural language;
inputting the analysis result data together with expression data and voice data of a user from the terminal device to an emotion recognition model to determine an emotion state parameter, and adjusting at least one of content, expression level, or presentation order of the feedback text based on the emotion state parameter; and
generating structured output data comprising the adjusted feedback text and analysis indices, and transmitting the structured output data to the terminal device.
